(19) United States
(12) Patent Application Publication
(10) Pub. No.: US 2022/0101474 A1
(43) Pub. Date: Mar. 31, 2022

(54) METHODS AND SYSTEMS FOR TRANSPOTATION ANALYSIS AND MANAGEMENT

(71) Applicant: BEIJING DIDI INFINITY TECHNOLOGY AND DEVELOPMENT CO., LTD., Beijing (CN)

(72) Inventors: Weiming LIU, Mountain View, CA (US); Jiandong Ding, Beijing (CN)

(73) Assignee: BEIJING DIDI INFINITY TECHNOLOGY AND DEVELOPMENT CO., LTD., Beijing (CN)

(21) Appl. No.: 17/643,608

(22) Filed: Dec. 10, 2021

Related U.S. Application Data
(63) Continuation of application No. PCT/CN2019/091429, filed on Jun. 14, 2019.

(30) Foreign Application Priority Data
Jun. 11, 2019 (CN) 201910501673.8

(51) Int. Cl. G06Q 50/30; G06Q 50/26; G06K 9/62

(52) U.S. Cl. CPC G06Q 50/30; G06K 9/6272; G06Q 50/26

(57) ABSTRACT

The present disclosure provides a method and system for analyzing and managing transportation. The method may include generating, for each of a plurality of geographic regions, a first graph representation based on transportation data relating to transport activities within the geographic region. The method may also include obtaining, for any two of the plurality of geographic regions, via a graph kernel based algorithm, a first similarity indicator measuring a similarity between the first graph representations of the any two of the plurality of geographic regions. The method may further include grouping, based on the first similarity indicators, the plurality of geographic regions into a plurality of groups. The method may also include, for each of the plurality of groups, identifying at least one featured transportation type of the group and associating a strategy to the group to promote or restrict transport activities of the at least one featured transportation type of the group.

### CROSS REFERENCE TO RELATED APPLICATIONS

This application is a continuation of International Application No. PCT/CN2019/091429, filed on Jun. 14, 2019, which claims priority of Chinese Application No. 201910501673.8 filed on Jun. 11, 2019, the entire contents of each of which are hereby incorporated by reference.

### TECHNICAL FIELD

The disclosure relates generally to the field of transportation analysis and management, and more specifically to methods and systems for transportation analysis and management using graph representations of geographic regions.

### BACKGROUND

With the developing of a city, methods are desired for managing and optimizing the increased transportation within the city. Cities bearing sufficient similarity on their transportation may be managed via similar strategies. However, traditionally, cities are grouped in view of their geographic features, administrations, size, populations, etc. Such a grouping may not focus on the similarity of transportation of different cities, and thus be of limited help for making strategies for managing transportation of a city.

### SUMMARY

An aspect of the present disclosure provides a method for analyzing and managing transportation. The method may include generating, for each of a plurality of geographic regions, a first graph representation based on transportation data relating to transport activities within the geographic region. The method may also include obtaining, for any two of the plurality of geographic regions, via a graph kernel based algorithm, a first similarity indicator measuring a similarity between the first graph representations of the any two of the plurality of geographic regions. The method may further include grouping, based on the first similarity indicators, the plurality of geographic regions into a plurality of groups. The method may also include, for each of the plurality of groups, identifying at least one featured transportation type of the group and associating a strategy to the group to promote or restrict transport activities of the at least one featured transportation type of the group.

In some embodiments, the transportation data may include, for each of the transport activities, points of interest (POIs), which correspond to a departure location and a destination location of the transport activity respectively and belong to a plurality of POI types. The first graph representation may include a plurality of first vertices and a plurality of first edges. Each of the plurality of first vertices may represent a POI type of the plurality of POI types. Each of the plurality of first edges may represent transport activities between the POIs of the corresponding POI types, and have a weight associated with at least a number of the transport activities represented by the first edge.

In some embodiments, the generating, for each of a plurality of geographic regions, a first graph representation based on transportation data may include: generating, based on the transportation data associated with the geographic region, a second graph representation of the geographic region, wherein the second graph representation may include a plurality of second vertices and a plurality of second edges; selecting the plurality of first vertices from the plurality of second vertices based on the second graph representation; and generating the first graph representation using the plurality of first vertices.

In some embodiments, the selecting the plurality of first vertices may include: associating a score with each of the plurality of the second vertices. The selecting the plurality of first vertices may also include, for each of the plurality of second vertices: (i) obtaining scores of one or more neighbor vertices of a current second vertex, the one or more neighbor vertices connecting to the current second vertex with one or more second edges; (ii) obtaining weights of the one or more second edges; (iii) updating, based at least on the scores of the one or more neighbor vertices and the weights of the one or more second edges, the score of the current second vertex; and (iv) repeating (i), (ii), and (iii)until a termination condition is satisfied. The selecting the plurality of first vertices may further include selecting the plurality of first vertices based on the scores of the second vertices.

In some embodiments, the second graph representation may be in a form of an adjacency matrix. Each element of the adjacency matrix may be a weight of the corresponding second edge. The selecting the plurality of first vertices from the plurality of second vertices may include: obtaining a stochastic matrix based on the adjacency matrix; calculating an eigenvector of the stochastic matrix; and selecting the plurality of first vertices from the plurality of second vertices based on the eigenvector.

In some embodiments, he identifying at least one featured transportation type of the group may include: obtaining a first featured graph representation of the group; identifying a plurality of transportation types based on the first featured graph representation; quantifying each of the plurality of transportation types by associating the transportation type with a quantified number based at least on weights of edges of the first featured graph representation associated with the transportation type; and selecting, from the plurality of transportation types, the at least one featured transportation type of the group by ranking the plurality of transportation types based on the quantified numbers.

In some embodiments, the method may further include: receiving a transportation request to initiate a target transport activity within a target geographic region; identifying, from the plurality of groups, a target group of the target geographic region using a classifier, wherein the classifier may be obtained based on the result of the grouping; identifying, based on at least one POI included in the transportation request, a target transportation type of the target transport activity; and providing, based on the strategy associated with the target group and the target transportation type, first data to a mobile computing device associated with a vehicle involved in the target transport activity, causing the vehicle to be more frequently or less frequently involved in transport activities of the target transportation type.

In some embodiments, the first data may cause the mobile computing device to generate a presentation on a display of the mobile computing device. The presentation may include information to encourage or discourage a user of the mobile computing device to participate transport activities of the target transportation type.

In some embodiments, the vehicle may be an unmanned vehicle controlled by the mobile computing device. The first data may modify one or more parameters of the mobile computing device to change the cruising manner of the vehicle or to change a response of the vehicle towards transportation request corresponding to the target transportation type.

In some embodiments, the identifying, from the plurality of groups, a target group of the target geographic region using a classifier may include: generating a target graph representation of the target geographic region based on transportation data relating to transport activities within the target geographic region, and; obtaining, for each of the plurality of groups, a second similarity indicator indicating a similarity between the target graph representation and a second featured graph representation of the group; and designating, as the target group, a group of the plurality of groups having a highest similarity via the second similarity indicator.

In some embodiments, the identifying, from the plurality of groups, a target group of the target geographic region using a classifier may include: inputting transportation data relating to transport activities within the target city into the classifier. The classifier may be trained via a machine-learning algorithm using a training dataset that is obtained based on the result of the grouping.

In some embodiments, a graph kernel involved in the graph kernel based algorithm may be a kernel based on walks or paths, or a kernel based on sub-trees.

In some embodiments, the grouping, based on the first similarity indicators, the plurality of geographic regions into a plurality of groups may include clustering, based on the first similarity indicators, the plurality of geographic regions via a clustering algorithm to obtain a plurality of clusters, each of which corresponds to one of the plurality of groups.

In some embodiments, the clustering algorithm may be a K-means algorithm, a hierarchical cluster analysis algorithm, or a graph community detection algorithm.

According to another aspect of the present disclosure, a system for analyzing and managing transportation is provided. The system may include at least one storage medium including a set of instructions for training a learner model, and at least one processor in communication with the storage medium. When executing the set of instructions, the at least one processor may be directed to generate, for each of a plurality of geographic regions, a first graph representation based on transportation data relating to transport activities within the geographic region. The at least one processor may be directed further to obtain, for any two of the plurality of geographic regions, via a graph kernel based algorithm, a first similarity indicator measuring a similarity between the first graph representations of the any two of the plurality of geographic regions. The at least one processor may be directed further to group, based on the first similarity indicators, the plurality of geographic regions into a plurality of groups. The at least one processor may be directed further to, for each of the plurality of groups: identify at least one featured transportation type of the group, and associate, a strategy to the group to promote or restrict transport activities of the at least one featured transportation type of the group.

According yet to another aspect of the present disclosure, a non-transitory computer readable medium including at least one set of instructions compatible for analyzing and managing transportation is provided. When executed by at least one processor of one or more electronic devices, the at least one set of instructions may direct the at least one processor to generate, for each of a plurality of geographic regions, a first graph representation based on transportation data relating to transport activities within the geographic region. The at least one processor may also be directed to obtain, for any two of the plurality of geographic regions, via a graph kernel based algorithm, a first similarity indicator measuring a similarity between the first graph representations of the any two of the plurality of geographic regions. The at least one processor may further be directed to group, based on the first similarity indicators, the plurality of geographic regions into a plurality of groups. The at least one processor may further be directed to, for each of the plurality of groups: identify at least one featured transportation type of the group; and associate, a strategy to the group to promote or restrict transport activities of the at least one featured transportation type of the group.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTIONS OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary transportation analysis and management system according to some embodiments of the present disclosure;

FIG. 2 is a schematic diagram illustrating an exemplary computing device;

FIG. 3 illustrates an exemplary transportation analysis module according to some embodiments of the present disclosure;

FIG. 4 is a flowchart illustrating an exemplary transportation analysis process according to some embodiments of the present disclosure;

FIG. 5 is a schematic diagram illustrating an exemplary graph according to some embodiments of the present disclosure;

FIG. 6 is a schematic diagram illustrating an exemplary undirected edge according to some embodiments of the present disclosure;

FIG. 7 is a schematic diagram illustrating an exemplary directed edge according to some embodiments of the present disclosure;

FIG. 8 is a schematic diagram illustrating an exemplary adjacency matrix of a graph according to some embodiments of the present disclosure;

FIG. 9 is a schematic diagram illustrating an exemplary adjacency matrix including the plurality of first similarity indicators;

FIG. 10 is a schematic diagram illustrating an exemplary agglomerative hierarchical cluster analysis clustering algorithm according to some embodiments of the present disclosure;

FIG. 11 is a flowchart illustrating an exemplary clustering process according to some embodiments of the present disclosure;

FIG. 12 is a schematic diagram illustrating an exemplary first graph representation sub-module according to some embodiments of the present disclosure;

FIG. 13 is a flowchart illustrating an exemplary process for generating a first graph representation of a city according to some embodiments of the present disclosure;

FIG. 14 is a schematic diagram illustrating an exemplary transportation management module according to some embodiments of the present disclosure; and

FIG. 15 is a flowchart illustrating an exemplary transportation management process according to some embodiments of the present disclosure;

### DETAILED DESCRIPTION

Embodiments of the present disclosure provide methods and systems for efficient analyzing and/or managing transportation of a plurality of cities. The plurality of cities may be grouped in view of the transportation to form a plurality of city groups, and one or more feature transportation types may be identified for each city group. In some embodiments of the present disclosure, a managing algorithm may be associated with each of the city group for managing transportation within the cities of the city group.

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

In the following detailed description, numerous specific details are set forth by way of examples in order to provide a thorough understanding of the relevant disclosure. However, it should be apparent to those skilled in the art that the present disclosure may be practiced without such details. In other instances, well known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a”, “an”, and “the” may be intended to include the plural forms as well, unless the context clearly indicates otherwise. It will be further understood that the terms “comprise”, “comprises”, and/or “comprising”, “include”, “includes”, and/or “including”, when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “unit,” “module,” and/or “block” used herein are one method to distinguish different components, elements, parts, section or assembly of different level in ascending order. However, the terms may be displaced by another expression if they achieve the same purpose.

Generally, the word “module,” “sub-module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts.

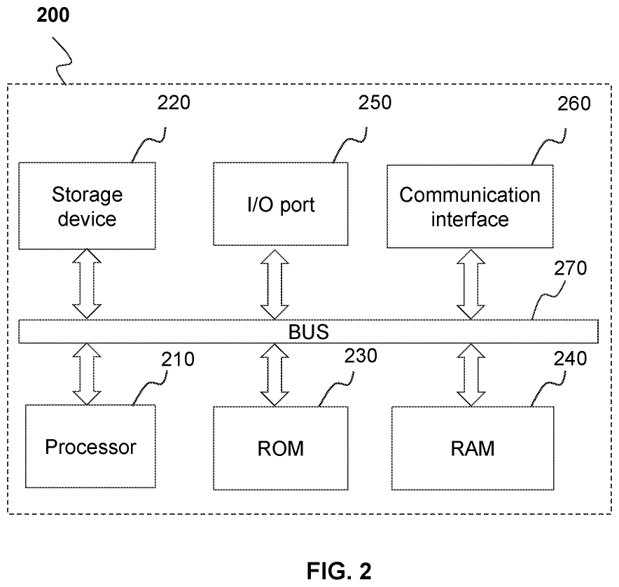

Software modules/units/blocks configured for execution on computing devices (e.g., processor 210 as illustrated in FIG. 2) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device.

Software instructions may be embedded in a firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure.

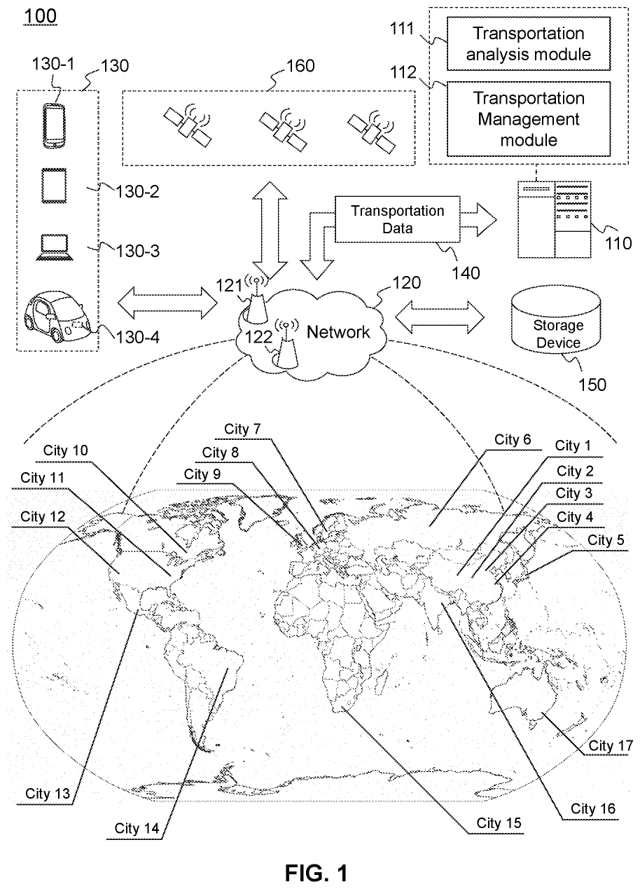

FIG. 1 is a schematic diagram illustrating an exemplary transportation analysis and management system according to some embodiments of the present disclosure. System 100 may include a server 110, a network 120, a plurality of terminal devices 130, a storage device 150, and a positioning system 160.

The server 110 may include a transportation analysis module 111 for analyzing transportation of a plurality of geographic regions. In some embodiments, the server 110 may further include a transportation management module 112 to manage transportation of different geographic regions based on the analysis result. Geographic regions in the present disclosure may generally refer to human settlements, such as districts, towns, cities, provinces, or the like, or a combination thereof. The geographic regions are not limited regions of the same type/level. For example, the geographic regions of which the transportation is to be analyzed may include a town as a first geographic region and a district of a metropolis as a second geographic region.

For demonstration purposes and not intended to be limiting, the present disclosure may be described by way of example with reference to analysis/management of transportation in different cities.

The server 110 (or the transportation analysis module 111) may collect transportation data 140 of a plurality of cities (or geographic regions of any other types) via the network 120 for analyzing transportation of the plurality of cities. By performing the analysis of transportation, the transportation analysis module 111 may group the plurality cities into a plurality of city groups based on the transportation data.

In some embodiments, for each of the plurality of city groups, the transportation analysis module 111 may further identify at least one featured transportation type of the city group and associate a strategy to the city group to promote or restrict the at least one featured transportation type. The transportation management module 112 may manage transportation of a city based on the associated strategy of the city group the city belongs to.

In some embodiments, based on the grouping result, the transportation analysis module 111 may generate a grouping model for classifying a city into one of the plurality of city groups. Such a grouping model may be used for classifying an unknown city (a city not involved in the grouping). To manage transportation of a target city, the transportation management module 112 may identify the city group of the target city via the grouping model and manage transportation of the target city based on the strategy associated to the identified city group.

The transportation data 140 may include data representing transport activities of different cities. A transport activity may refer to an activity of taking things or one or more passengers from one place to another in a vehicle (e.g., a car, a bicycle, a motorcycle, a truck, a bus, a boat, a railway vehicle, an aerial vehicle). The transportation data 140 associated with one transport activity may be generated by a terminal device 130 associated with a corresponding vehicle performing the transport activity. For a single transport activity, the associated transportation data may include two point of interests (POIs), corresponding to the departure location (or start location) and the destination location (or ending location), respectively. For simplicity, a POI corresponding to the departure location may be referred to as a departure POI, and a POI corresponding to the destination location may be referred to as a destination POI.

In some embodiments, in situations such as carpool, a vehicle may be shared by multiple passengers (or goods to be delivered) at the same time, each of which may have a departure location and a destination location (some of the plurality of passengers may share a same departure location and/or destination location). The server 110 may treat the shared transportation performed by the vehicle as a corresponding number of transport activities, one for each passenger.

The server 110 may be a single server or a server group. The server group may be centralized, or distributed (e.g., the server 110 may be a distributed system). The server 110 may be local or remote. The transportation analysis module 111 and the transportation management module 112 may be implemented by a same server or different servers.

The server 110 may access information and/or data stored in the terminal device 130, and/or the storage device 150 via the network 120. In some embodiments, the server 110 may be directly connected to the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the server 110 may have a structure the same as or similar to that of a computing device 200 as illustrated in FIG. 2. For example, the server 110 may include one or more processors (e.g., the processor 210) and one or more storage devices (e.g., the storage device 220, the RAM 240).

The network 120 may facilitate the exchange of information and/or data. In some embodiments, one or more components in the system 140 (e.g., the server 110, the server 110, the terminal device 130, the storage device 150, and the positioning system 160) may send information and/or data to other component(s) in the system 140 via the network 120. For example, the server 110 may retrieve transportation data 140 from the terminal device 130 or the storage device 150 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a public telephone switched network (PSTN), a cellular network, a Bluetooth™ network, a ZigBee network, a near field communication (NFC) network, or the like, or any combination thereof. In some embodiments, the network 120 may include one or more network access points. For example, the network 120 may include wired or wireless network access points such as base stations (e.g., base stations 121 and 122) and/or internet exchange points, through which one or more components of the system 100 may be connected to the network 120 to exchange data and/or information.

The terminal device 130 may generate the transportation data 140, which may be transmitted to the server 110 or the storage device 150 via the network 140. The terminal device 130 may be a mobile computing device, which may be or may include a mobile phone 130-1, a tablet computer 130-2, a laptop computer 130-3, an on-board computing device 130-4, or the like, or any combination thereof. In some embodiments, the terminal device 130 may be or may include a wearable device, a virtual reality device, an augmented reality device, or the like, or any combination thereof. The wearable device may include a bracelet, footgear, glasses, a helmet, a watch, clothing, a backpack, a smart accessory, or the like, or any combination thereof. The virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, the on-board computing device 130-4 may include an onboard computer, television, navigation system, etc.

In some embodiments, the terminal device 130 may be a device with positioning technology for locating the current position of the terminal device 130. The terminal device 130 may include a positioning module (e.g., a GPS module) to communicate with the positioning system 160. The positioning system 160 may provide the terminal device 130 information on the location and/or movement of the terminal device 130 (or a vehicle associated with the terminal device 130). In some embodiments, the location of the terminal device 130 may be used to generate the transportation data 140.

The storage device 150 may store data and/or instructions. For example, the storage device 150 may store a database recording historical data of the server 110. As another example, the storage device 150 may store data obtained from the terminal device 130.

The storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc.

In some embodiments, the storage device 150 may be implemented on a cloud platform. The storage device 150 may be connected to the network 120 to communicate with one or more components in the system 100 (e.g., the server 110, the terminal device 130). One or more components in the system 100 may access the data or instructions stored in the storage device 150 via the network 120.

In some embodiments, the storage device 150 may be directly connected to or communicate with one or more components in the system 100 (e.g., the server 110, the terminal device 130).

In some embodiments, the storage device 150 may be part of the server 110. For example, the storage device 150 may store data and/or instructions that the server 110 may execute or use to perform exemplary methods described in the present disclosure.

The positioning system 160 may determine information on location and movement of the terminal device 130 (or a vehicle associated with the terminal device 130). In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The location may be in the form of coordinates, such as, latitude coordinate and longitude coordinate, etc. The positioning system 160 may include one or more satellites, which may determine the above information independently or jointly. The positioning system 160 may send the determined information to the terminal device 130, or the provider terminal 140 via the network 120.

By performing the transportation analysis and transportation management approaches described in the present disclosure, management strategies may be made according to similarities between transportation states of different cities, so as to improve the effect of transportation management.

For example, the system 100 may obtain common features (e.g., featured transportation type) of different cities (or geographic regions of any other types) in view of transportation in the cities, no matter the geographic features, administration, population, size, etc. of the cities. Techniques associated with data mining may be introduced into the transportation analysis to improve the result. After the transportation analysis, cities included in the analysis may be grouped into a plurality of city groups based on their similarity (determined by the system 100) with each other on transportation.

For example, the system 100 may group cities within a same country (e.g., Cities 1 to 4) or widely across the world (e.g., Cities 1 to 17). Different cities, no matter how different in their sizes, population distributions, and geographic locations are, may be grouped into a same city group if sufficient similarity is found on their, e.g., distribution of transportation types. A same strategy or similar strategies may be adopted for managing transportation of cities belonging to the same city group. For example, cities of the same city group may share at least one featured transportation type, and a strategy associated to the city group may promote or suppress the at least one featured transportation type.

A type of a transport activity may be defined by types (or labels) of the corresponding departure POI and/or the destination POI. For example, a transport activity having a departure POI labeled as residential district or home and a destination POI labeled as industrial district or work may have a type of commute. As another example, a transport activity having a destination POI labeled as entertainment district may have a type of entertainment. Still as another example, a transport activity having a destination POI labeled as airport or railway station may be labeled as journey. It is noted that, the above cases are just for demonstration purposes, and actual cases may be much more complicated. For example, the types of POIs (or be referred to as POI types) may be very detail and huge on number. Exemplary POI types may include shopping, scenic spot, hotel, neighborhood, food, entertainment, education, library, religion, health service, entity, transportation junction, emergency, etc. Correspondingly, the number of types of transport activities (or be referred to as transportation types) may be enormous.

The above exemplary POI types may be further divided into subordinate POI types. For example, a superior POI type of entertainment may be further divided into subordinate POI types such as club, amusement park, teahouse, sports field, theater, gym, etc. In some embodiments, a subordinate POI type may further include time information. For example, a POI type of entertainment may be further divided into subordinate POI types such as entertainment at daytime, entertainment at night, entertainment at workday, entertainment at weekends, all the like, or a combination thereof.

The system 100 may be implemented in various application scenarios. Exemplary scenarios are described below, which are only for demonstration purposes and not intended to be limiting.

In some embodiments, the system 100 may act as a navigation system, which may, in response to a navigation request (e.g., transmitted via the terminal device 130), determine a route for guiding a vehicle (manned vehicle or unmanned vehicle) from a departure location to a destination location indicated by the navigation request. The departure locations and the destination locations of historical navigation requests of different cities may be stored in the storage device 150, and may be retrieved by the server 110 as at least part of the transportation data 140 for grouping different cities into a plurality of city groups, each of which may be associated with a different route determination strategy. Then to determine a route in a city, the navigation system may be configured to identify its city group, and then use a corresponding route determination strategy to determine the route. Such a route determination approach may take the transportation type distribution of the city into consideration, and may avoid potential traffic jams caused by certain transportation type.

In some embodiments, the server 110 may act as an online-to-offline transportation service platform. Via the online-to-offline transportation service platform, a user may send a service request (e.g., transmitted via the terminal device 130) for carrying the user or goods ordered by the user from a departure location to a destination location, and a transportation service provider (e.g., a driver) may accept a service request and profit by performing the transport activity indicated by the accepted service request. The departure locations and the destination locations of historical service requests may be stored in the storage device 150, and may be retrieved by the server 110 as at least part of the transportation data 140 for grouping different cities into a plurality of city groups. Each of the plurality of city groups may be associated with a different incentive strategy, which may encourage or discourage a transportation service provider to accept service requests of certain transportation type(s). The service providers may then be more frequently or less frequently driving around a place where the encouraged or discouraged service requests are more easily to receive, thereby to facilitate users in different cities to get driving services more easily and/or optimize the transportation states of different cities.

In some embodiments, the transportation service providers in the above case may be unmanned vehicles. Different unmanned vehicles may have different cruise routes or cruise regions. Each city group may then be associated with a different control strategy, which may be used to determine cruise routes or cruise regions of unmanned vehicles in a city. By adopting different control strategies to determine cruise routes or cruise regions of unmanned vehicles in cities having different transportation type distributions, the unmanned vehicle may be more frequently or less frequently cruising around a place where the encouraged or discouraged service requests are more easily to receive.

In some embodiments, the server 110 may act as a government transportation management system. The management system may record running data or location data of a plurality of vehicles (manned or unmanned) in the storage device 150. The departure locations and the destination locations in the recorded data may be retrieved by the server 110 as at least part of the transportation data 140 for grouping different cities (or different districts of one or more cities) into a plurality of city groups. The management system may identify at least one featured transportation type of each group and may generate a corresponding report. The report may facilitate the government to make development plan of one or more cities. For example, a traffic-facilities-construction plan of a city may be made according to another city in the same city group.

It may be noted that, the above descriptions about system 100 are only for illustration purposes, and not intended to limit the present disclosure. It is understood that, after learning the major concept and the mechanism of the present disclosure, a person of ordinary skill in the art may alter system 100 in an uncreative manner. The alteration may include combining and/or splitting components of the system 100, adding or removing optional components, etc. The system 100 may also have other application scenarios. All such modifications are within the protection scope of the present disclosure.

FIG. 2 is a schematic diagram illustrating an exemplary computing device. Computing device 200 may be configured to implement the server 110, and perform one or more operations disclosed in the present disclosure. The computing device 200 may be configured to implement various modules, units, and their functionalities described in the present disclosure.

The computing device 200 may include a bus 270, a processor 210 (or a plurality of processors 210), a read only memory (ROM) 230, a random access memory (RAM) 240, a storage device 220 (e.g., massive storage device such as a hard disk, an optical disk, a solid-state disk, a memory card, etc.), an input/output (I/O) port 250, and a communication interface 260. It may be noted that, the architecture of the computing device 200 illustrated in FIG. 2 is only for demonstration purposes, and not intended to be limiting. The computing device 200 may be any device capable of performing a computation.

The bus 270 may couple various components of computing device 200 and facilitate transferring of data and/or information between them. The bus 270 may have any bus structure in the art. For example, the bus 270 may be or may include a memory bus and/or a peripheral bus. The I/O port 250 may allow a transferring of data and/or information between the bus 270 and one or more other devices (e.g., a touch screen, a keyboard, a mouse, a microphone, a display, a loudspeaker). The communication interface 260 may allow a transferring of data and/or information between the network 130 and the bus 270. For example, the communication interface 260 may be or may include a network interface card (NIC), a Bluetooth™ module, an NFC module, etc.

The ROM 230, the RAM 240, and/or the storage device 220 may be configured to store instructions that may be executed by the processor 210. The RAM 240, and/or the storage device 220 may also store data and/or information generated by the processor 210 during the execution of the instruction.

The processor 210 may be or include any processor in the art configured to execute instructions stored in the ROM 230, the RAM 240, and/or the storage device 220, so as to perform one or more operations or implement one or more modules/units disclosed in the present disclosure. Merely by way of example, the processor 210 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

In some embodiments, one or more of the components of the computing device 200 may be implemented on a single chip. For example, the processor 210, the ROM 230, and the RAM 240 may be integrated into a single chip.

In some embodiments, one of the I/O port 250 and the communication interface 260 may be removed from the computing device 200.

The computing device 200 may be a single device or include a plurality of computing devices having a same or similar architecture as illustrated in FIG. 2. In some embodiments, the computing device 200 may implement a personal computer (PC) or any other type of work station or terminal device. The computing device 200 may also act as a server if appropriately programmed.

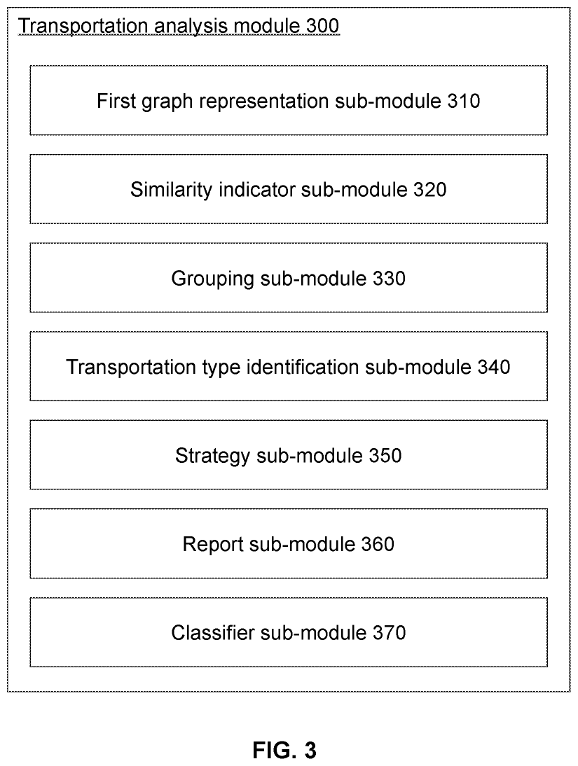

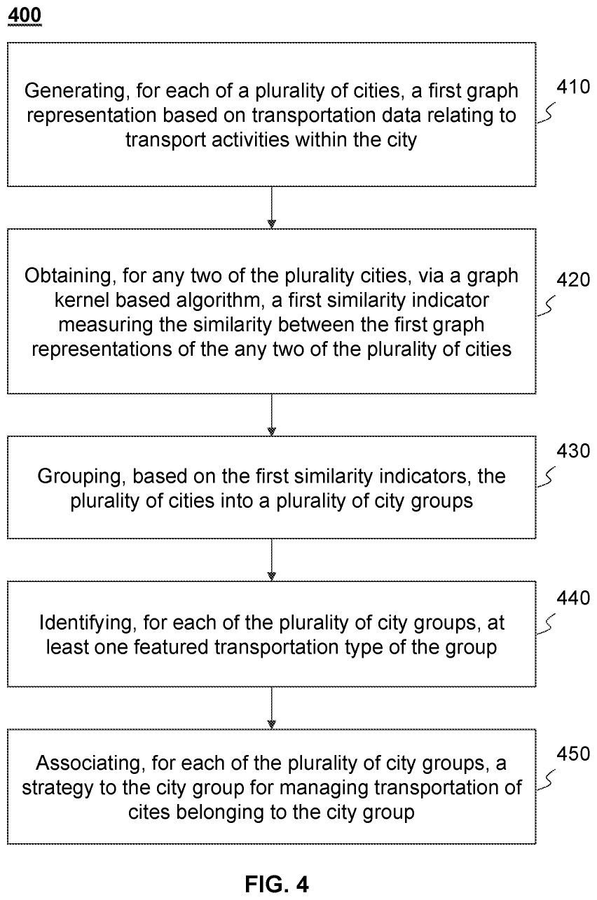

FIG. 3 illustrates an exemplary transportation analysis module (transportation analysis module 300) according to some embodiments of the present disclosure. The transportation analysis module 300 may be implemented by the server 110 to analyze transportation of a plurality of cities via a process illustrated in FIG. 4 or an embodiment thereof. The transportation analysis module 300 may include a first graph representation sub-module 310, a similarity indicator sub-module 320, a grouping sub-module 330, a transportation type identification sub-module 340, a strategy sub-module 360, a report sub-module 370, and a classifier sub-module 380.

The first graph representation sub-module 310 may generate, for each of a plurality of cities, a first graph representation based on transportation data relating to transport activities within the city.

The similarity indicator sub-module 320 may obtain, for any two of the plurality of cities, via a graph kernel based algorithm, a first similarity indicator measuring a similarity between the first graph representations of the any two of the plurality of cities.

The grouping sub-module 330 may group, based on the first similarity indicators, the plurality of cities into a plurality of city groups.

The transportation type identification sub-module 340 may identify, for each of the plurality of city groups, at least one featured transportation type of the city group.

The strategy sub-module 350 may associate, for each of the plurality of city groups, a strategy to the city group to promote or restrict the at least one featured transportation type of the city group.

The report sub-module 360 may generate a report including the plurality of city groups and the featured transportation types of the plurality of city groups.

The classifier sub-module 370 may generate a classifier based on the result of the grouping performed by the grouping sub-module 330.

The functions and operations of the sub-modules of the transportation analysis module 300 may be further described in connection with FIG. 4.

In some embodiments, one or more or the strategy sub-module 360, the report sub-module 370, and the classifier sub-module 380 may be removed from the transportation analysis module 300.

It may be noted that, the above descriptions about the transportation analysis module 300 are only for illustration purposes, and not intended to limit the present disclosure. It is understood that, after learning the major concept and the mechanism of the present disclosure, a person of ordinary skill in the art may alter the transportation analysis module 300 in an uncreative manner. The alteration may include combining and/or splitting sub-modules, adding or removing optional sub-modules, etc. All such modifications are within the protection scope of the present disclosure.

FIG. 4 is a flowchart illustrating an exemplary transportation analysis process (process 400) according to some embodiments of the present disclosure. The process 400 may be performed by the transportation analysis module 300 to analyze transportation of different cities. In some embodiments, one or more operations of the process 400 illustrated in FIG. 4 may be implemented in the system 100 illustrated in FIG. 1. For example, the process 400 illustrated in FIG. 4 may be stored in a storage device (e.g., the RAM 240, the storage device 220) in the form of instructions, and invoked and/or executed by one or more processors (e.g., the processor 210) implementing the corresponding sub-modules of the transportation analysis module 300.

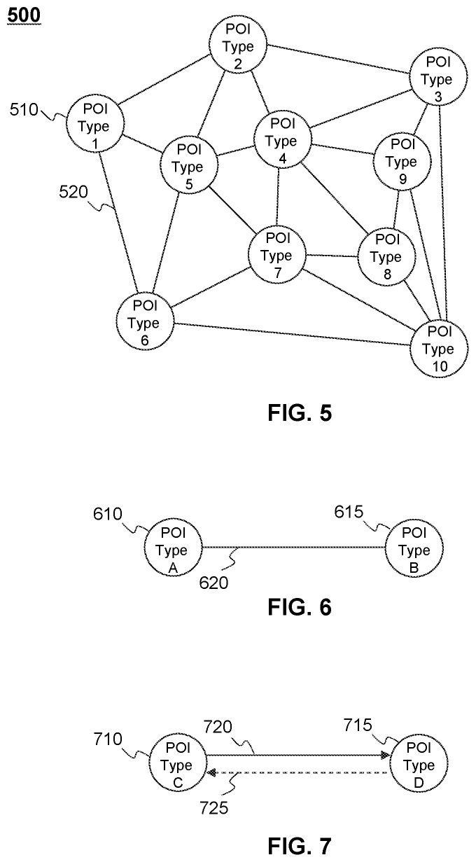

For demonstration purposes and not intended to be limiting, the process 400 may be described in connection with FIGS. 5 to 11. Unless otherwise noted, the same symbols or parameters in the descriptions of the FIGS. 4 to 11 may hold the same meaning.

In 410, the first graph representation sub-module 310 may generate, for each of a plurality of cities (e.g., at least two cities), a first graph representation based on transportation data (e.g., transportation data 140) relating to transport activities within the city. The transportation data may include or record a plurality of transport activities within the city initiated within a predetermined time period (e.g., a day, a week, two weeks, a month, three months, six months, a year). Each of the plurality of transport activities may include a departure POI and a destination POI. The POIs included in the transportation data may belong to a plurality of POI types (e.g., as described in connection with FIG. 1).

The transportation data may be related to a navigation system, an online-to-offline transportation service platform, a government transportation management system, etc. The first graph representation sub-module 310 may obtain the transportation data from one or more local storage devices (e.g., the storage device 220, the RAM 240) and/or one or more online storage devices (e.g., the storage device 150) via the network 120. Alternatively or additionally, the first graph representation sub-module 310 may obtain the transportation data from one or more terminal devices 130.

According to the transport activities included or recorded in the transportation data, the first graph representation sub-module 310 may generate first graph representations of the plurality of cities. In the present disclosure, a graph representation may refer to a weighted and labeled graph or a data form of the graph. FIG. 5 is a schematic diagram illustrating an exemplary graph (graph 500) according to some embodiments of the present disclosure.

Generally, a graph may include a plurality of vertices (e.g., vertex 510) and a plurality of edges (e.g., edge 520). The number of the plurality of vertices and the number of the plurality of edges may be two or more. A vertex of the graph may represent one of the set of objects, and an edge may represent a “relationship” between a pair of related objects in the set of objects. Each of the plurality of edges may be associated with a weight serving as a metric of the strength of the “relationship”. Depending on the problem to be solved with the graph, vertices and edges of the graph may have various actual meanings.

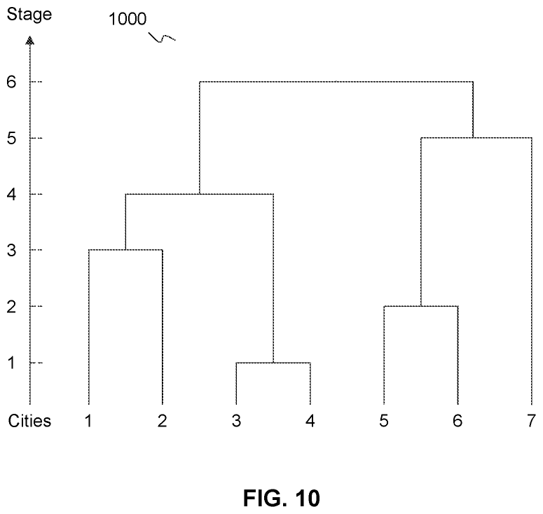

In the present disclosure, a vertex of a graph may represent a POI type (e.g., POI type 1 to POI type 10 illustrated in FIG. 10). For example, the graph may include a look-up table and/or a mapping function to label each vertex (i.e., to build an association between the each vertex and the corresponding POI type). An edge of a graph may represent transport activities (recorded or included in the transportation data) between POIs of the POI types represented by the vertices connected by the edge. Each edge of a graph may has a weight associated with at least the number of the transport activities represented by the edge. For example, the weight may be a measure of the amount of transport activities represented by the corresponding edge, such as the total number of transport activities represented by the edge. It is understood that, the number of vertices (or POI types) may be set based on the transportation data or according to actual needs, and is not limited to ten as illustrated in FIG. 5. In some embodiments, the number of vertices may be in a range of [10, 200]. In some more preferable embodiments, the number of vertices may be in a range of [60, 150].

In the present disclosure, a graph representation may be an undirected graph or a directed graph. An edge (or be referred to as an undirected edge) of an undirected graph may not include valid information on directions of the associated transport activities, while an edge (or be referred to as a directed edge) of a directed graph may further include information on directions of the associated transport activities.

FIG. 6 is a schematic diagram illustrating an exemplary undirected edge according to some embodiments of the present disclosure. A pair of vertices 610 and 615 may be connected by an undirected edge 620. The vertex 610 may represent a POI type A, which may be associated with a first plurality of POIs. The vertex 620 may represent a POI type B, which may be associated with a second plurality of POIs. The undirected edge 620 may represent transport activities between any one of the first plurality of POIs and any one of the second plurality of POIs, no matter the directions of the transport activities.

Transport activities from any one of the first plurality of POIs to any one of the second plurality of POIs or from any one of the second plurality of POIs to any one of the first plurality of POIs may be used (e.g., by the first graph representation sub-module 310) for computing a weight associated with the undirected edge 620. For example, the weight may be the total number of transport activities represented by the undirected edge 620, a ratio of the total number of transport activities represented by the undirected edge 620 to the total number of transport activities involved in the whole graph, a ratio of the total number of transport activities represented by the undirected edge 620 to the mean of the number of transport activities of each edge, etc.

FIG. 7 is a schematic diagram illustrating an exemplary directed edge according to some embodiments of the present disclosure. A pair of vertices 710 and 715 may be connected by a directed (or oriented) edge 720 directed from the vertex 710 to the vertex 715. The vertex 710 may represent a POI type C, which may be associated with a third plurality of POIs. The vertex 715 may represent a POI type D, which may be associated with a fourth plurality of POIs. The directed edge 720 may only represent transport activities from any one of the third plurality of POIs to any one of the fourth plurality of POIs. With respect to the directed edge 720, the vertices 710 may be referred to as a departure vertex, while the vertex 715 may be referred to as a destination vertex.

When there are one or more transport activities from any one of the fourth plurality of POIs to any one of the third plurality of POIs, another directed edge 725 directed from the vertex 715 to the vertex 710 may be used to represent such transport activities. With respect to the directed edge 725, the vertices 715 may be referred to as a departure vertex, while the vertex 710 may be referred to as a destination vertex.

Transport activities from any one of the third plurality of POIs to any one of the fourth plurality of POIs may be used (e.g., by the first graph representation sub-module 310) for computing a weight associated with the directed edge 720. For example, the weight may be the total number of transport activities represented by the directed edge 720, a ratio of the total number of transport activities represented by the directed edge 720 to the total number of transport activities involved in the whole graph, a ratio of the total number of transport activities represented by the directed edge 720 to the mean of transport activities for each edge, a ratio of the total number of transport activities represented by the directed edge 720 to the total number of transport activities starting from any one of the third plurality of POIs, etc. Similarly, a weight associated with the directed edge 725 (if any) may be computed using transport activities from any one of the fourth plurality of POIs to any one of the third plurality of POIs.

The transportation analysis module 300 may use various data structures to store weights of the graph. In some embodiments, the transportation analysis module 300 may use an adjacency matrix to store weights of a graph. In the present disclosure, an adjacency matrix of a graph may be directly used to refer to the corresponding graph.

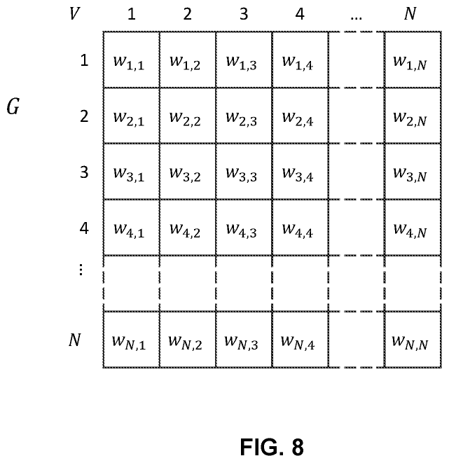

FIG. 8 is a schematic diagram illustrating an exemplary adjacency matrix of a graph according to some embodiments of the present disclosure.

The adjacency matrix A illustrated in FIG. 8 may represent a graph G including N vertices where N is an integer above 2. The rows and columns of the adjacency matrix A may represent the N vertices. A row and a column having the same index number may represent a same vertex. The adjacency matrix A may store weights of the edges of the corresponding graph. As illustrated in FIG. 8, a weight w_{i,j} may correspond to an edge (i,j) starting from the ith vertex Vⱼ, to the jth vertex Vⱼ, where i and j are integers between 1 and N. When there is no edge starting from the vertex Vᵢ to the vertex Vⱼ in the graph, the weight w_{i,j} in the adjacency matrix A may be zero.

According to actual needs, the graph G may be an undirected graph or a directed graph. For an undirected graph, edge (i,j) and edge (j,i) may represent the same edge (e.g., edge 620), and w_{i,j}=w_{j,i}. For a directed graph, edge (i,j) and edge (j,i) represent different edges (e.g., edges 720 and 725), and w_{i,j} and w_{j,i} may be obtained based on the transportation data, respectively.

Referring back to FIG. 4. During the operation 410, the first graph representation sub-module 310 may generate, based on the transportation data, a graph representation G_{d,0} for a dth city of the plurality of cities, where d is an integer between 1 and the total number D of the plurality of cities. The graph representation G_{d,0} may be an undirected graph or a directed graph. The graph representation G_{d,0} may have, for example, N vertices corresponding to N POI types. In some embodiments, N may be in a range of [10, 200].

In some embodiments, the graph representation G_{d,0} may have a data form as an adjacency matrix A_{d,0}. The size of the adjacency matrix A_{d,0} may be N×N. The ith (1≤i≤N) row or column of the adjacency matrix A_{d,0} may correspond to the ith vertex Vᵢ of the graph representation G_{d,0} which may in turn correspond to the ith POI type of the N POI types. Such a correspondence may be in the form of a mapping function and/or a look-up table associated with the adjacency matrix A_{d,0}. The mapping function and/or the look-up table may be predetermined and included in the graph representation G_{d,0}.

To generate the adjacency matrix A_{d,0} of the dth city, the first graph representation sub-module 310 may generate a blank matrix Aₒ having the size of N×N. The blank matrix Aₒ may be the initial version of the adjacency matrix A_{d,0}, and be associated with a predetermined mapping function and/or look-up table to label the N vertices of the graph representation G_{d,0}. The weights stored in the blank matrix may have initial values such as 0. After obtaining, from the transportation data, data on a departure POI P_{1,n} and a destination POI P_{2,n} of an nth transport activity in the dth city included in the transportation data, where n is an integer between 1 and the total number T_{d o}f transport activities in the dth city, the first graph representation sub-module 310 may identify (e.g., via the look-up table and/or the mapping function of the graph) that the departure POI P_{1,n} corresponds to, e.g., the vertex Vᵢ of the graph representation G_{d,0} and the destination POI P_{2,n} corresponds to, e.g., the vertex Vⱼ of the graph representation G_{d,0}. The first graph representation sub-module 310 may then update a count c_{i,j} of transport activities associated with an edge (i,j) of the graph representation G_{d,0}. After processing all the T_{d} transport activities accordingly in the dth city, the first graph representation sub-module 310 may obtain a weight (e.g., w_{i,j}) for each edge of the graph representation G_{d,0} based on the corresponding count (e.g., c_{i,j}). The first graph representation sub-module 310 may store the obtained weights into the blank matrix Aₒ to generate the adjacency matrix A_{d,0}.

In some embodiments, the count c_{i,j} may directly serve as the weight w_{i,j} and may be initially stored in the matrix Aₒ. Each time the first graph representation sub-module 310 update a count (e.g., c_{i,j}) associated with an edge (e.g., edge (i,j)) of the graph, the adjacency matrix A_{d,0} may be updated accordingly.

In some embodiments, the graph representation G_{d,0} may directly serve as the first graph representation G_{d} of the dth city and be subjected to the subsequent analysis.

In some embodiments, the graph representation G_{d,0} may serve as an original graph representation of the dth city. The first graph representation sub-module 310 may further process the graph representation G_{d,0} to generate the first graph representation G_{d} of the dth city.

In some embodiments, first graph representation sub-module 310 may process the original graph representation G_{d,0} via a processing pipeline to generate the first graph representation G_{d} of the dth city. The processing pipeline may include a plurality of sequential processing operations. For example, the first graph representation sub-module 310 may generate an intermediate graph representation based on the graph representation G_{d,0} or an upstream intermediate graph representation via a corresponding processing operation, and then process the intermediate graph representation via a subsequent processing operation to generate the first graph representation G_{d} of the dth city or a downstream intermediate graph representation.

For simplicity, in the present disclosure, an original graph representation or an intermediate graph representation may be referred to as a second graph representation. Exemplary operations for processing a second graph representation to generate the first graph representation G_{d} or another second graph representation are described as following, which are for demonstration purposes only and not intended to be limiting. The operations described as following may be optionally performed in accordance with the algorithm(s) adopted in one or more subsequent operations of the process 400.

In some embodiments, to obtain the first graph representation of the dth city, the first graph representation sub-module 310 may remove loops (if any) of a second graph representation Gx_{d} of the dth city (i.e., an original graph representation or an intermediate graph representation). A loop may be an edge (e.g., edge (i i)) starting from and ending at the same vertex (e.g., the vertex Vᵢ), which may correspond to transport activities whose departure POI and destination POI belonging to the same POI type. The first graph representation sub-module 310 may detect loops by detecting non-zero diagonal weights (e.g., w_{i,i}) in, for example, the adjacency matrix Ax_{d} of the second graph representation Gx_{d}.

In some embodiments, upon a detection of a non-zero diagonal weight, the first graph representation sub-module 310 may set the detected non-zero diagonal weight of the adjacency matrix Ax_{d} as zero to directly remove the corresponding loop, thereby obtaining a new adjacency matrix A_{d,1}. The adjacency matrix A_{d,1} may correspond to a new graph representation G_{d,1}, which may serve as the first graph representation G_{d} of the dth city or an intermediate graph representation (another second graph representation) of the dth city.

In some embodiments, upon a detection of a non-zero diagonal weight, the first graph representation sub-module 310 may split the vertex where the corresponding loop exists to eliminate the detected loop. For instance, the vertex to be split may correspond to a superior POI type P₀, which may include or be divided into subordinate POI types such as POI types P₁ and P₂. Before the vertex is split, transport activities having a departure POI corresponding to the POI type P₁ and a destination POI corresponding to the POI type P₂ may cause a loop at the vertex. Such a loop may be eliminated after the vertex is split into at least a vertex corresponding to the POI type P₁ and a vertex corresponding to the POI type P₂. By splitting the vertex having a loop instead of directly removing the loop, more information on transport activities of the dth city may be retained in the graph.

For example, before one or more vertices are split, the second graph representation Gx_{d} may have N vertices and the adjacency matrix Ax_{d} may be an N×N adjacency matrix. After one or more vertices of the N vertices are split into a plurality of new vertices, the graph representation G_{d,2} obtained thereby may have M vertices (M is an integer larger than N), and the adjacency matrix A_{d,2} of the graph representation G_{d,2} may have a size of M×M. Accordingly, the look-up table and/or the mapping function associated with the graph representation G_{d,1} may further include associations between the plurality of new vertices and their corresponding POI types, and optionally exclude the associations between the one or more split vertices and their corresponding POI types. The first graph representation sub-module 310 may obtain weights associated with the new vertices and store the weights in the corresponding positions in the adjacency matrix A_{d,2}. The graph representation G_{d,2} may serve as the first graph representation G_{d} of the dth city or an intermediate graph representation (another second graph representation) of the dth city.

The removing of loops (if any) may be performed when, for example the graph kernel based algorithm adopted in the operation 420 is not compatible with graphs having loops, one or more processing operations in the processing pipeline for generating the first graph representation G_{d} require to be performed on or have a better performance on graphs without loop, the result of grouping in the operation 430 is to be optimized, etc. Otherwise, the removing of loops may be skipped or omitted.

In some embodiments, to generate the first graph representation G_{d} of the dth city, the first graph representation sub-module 310 may select L vertices from vertices of a second graph representation Gx_{d} of the dth city, which may have a data form as, for example, an adjacency matrix Ax_{d}, where L is an integer between 2 and the total number (e.g., N, M) of the vertices of the second graph representation Gx_{d}. L may be a predetermined number or may depend on the result of the selection. In some embodiments, L may be in a range of [10, 30]. The first graph representation sub-module 310 may form a graph representation G_{d,3} of the dth city using the selected L vertices, which may have a data form as, for example, an adjacency matrix A_{d,3}.

In some embodiments, the first graph representation sub-module 310 may select the L vertices by ranking the vertices of the second graph representation Gx_{d} in view of their importances (or contributions) to the transport activities in the dth city. For example, the first graph representation sub-module 310 may compute, for each vertex of the second graph representation Gx_{d}, the sum of transport activities starting from and/or ending at POIs associated with the vertex or compute the sum of weights of edges starting from and/or ending at the vertex as a metric of the importance of the vertex, and then select the most important L vertices.

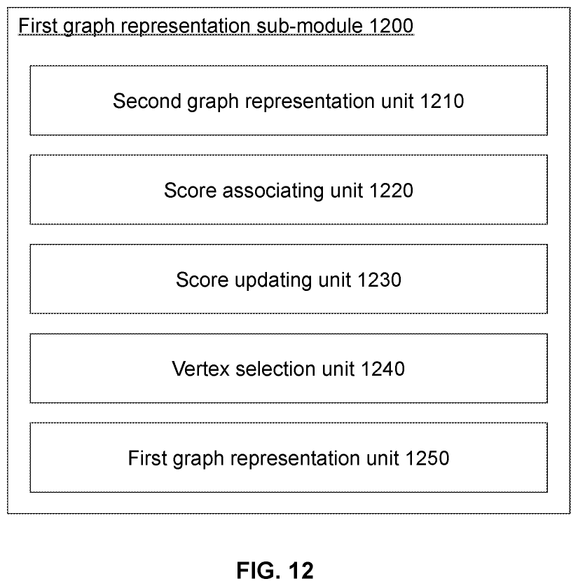

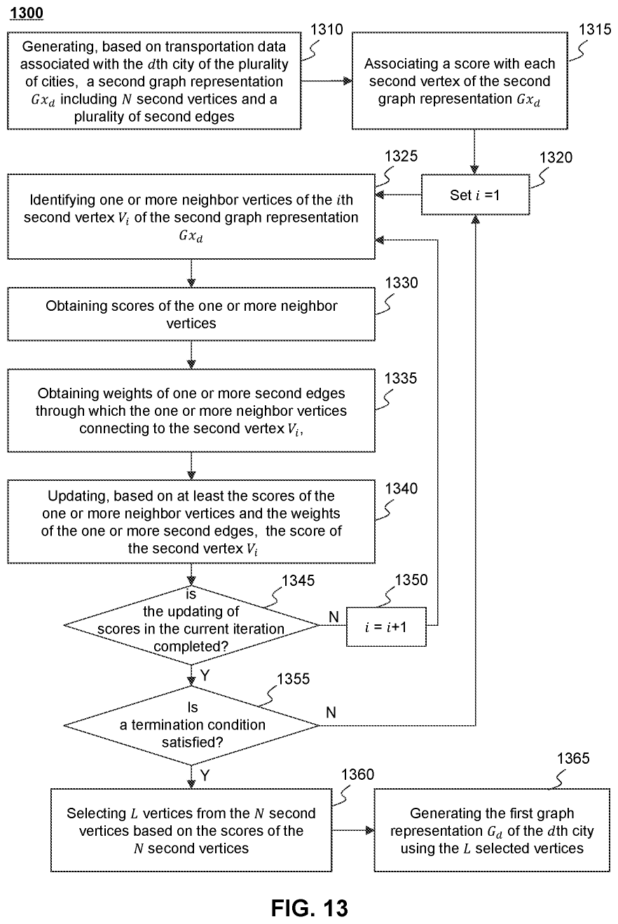

In some embodiments, the first graph representation module 310 may generate the first graph representation via a process including a selection of vertices as illustrated in FIG. 13. Correspondingly, the first graph representation module 310 may have a structure as illustrated in FIG. 12.

According to the graph kernel based algorithm to be adopted in the next operation 420, the adjacency matrix A_{d,3} may still maintain the same configuration of the adjacency matrix Ax_{d} or not.

In some embodiments, the adjacency matrix A_{d,3} may still maintain the same configuration of the adjacency matrix Ax_{d}. For example, the first graph representation sub-module 310 may generate the adjacency matrix A_{d,3} by setting the weights in the rows and columns of the adjacency matrix Ax_{d} corresponding to the vertices other than the L selected vertices as zeroes. The weights in the rows and columns corresponding to the L selected vertices may be maintained the same or be updated accordingly. As a result, same indexed rows/columns of the adjacency matrix A_{d,3} and the adjacency matrix Ax_{d} may represent a same POI type, and the look-up table and/or mapping function associated with the adjacency matrix A_{d,3} may be the same as the look-up table and/or mapping function associated with the adjacency matrix Ax_{d}.

In some embodiments, the adjacency matrix A_{d,3} may have a configuration different from that of the adjacency matrix Ax_{d}. For example, the size of the adjacency matrix A_{d,3} may be reduced to L×L. The first graph representation sub-module 310 may generate the adjacency matrix A_{d,3} by removing the rows and columns of the adjacency matrix Ax_{d} corresponding to the vertices other than the L selected vertices, or by generating a new L×L matrix using weights in the rows and columns of the adjacency matrix Ax_{d} corresponding to the L selected vertices. The weights in the rows and columns corresponding to the L selected vertices may be maintained the same or be updated accordingly. The look-up table and/or mapping function associated with the adjacency matrix A_{d,3} may also be updated accordingly.

The graph representation G_{d,3} may serve as the first graph representation G_{d} of the dth city or an intermediate graph representation (another second graph representation) of the dth city. The selection of vertices may be performed to reduce the consumption of computing resources and the time cost of one or more subsequent operations such as the operation 420, and/or to improve the result of the grouping in the operation 430. In some embodiments, the selection of vertices may also be skipped or omitted when the consumption of the computing resources and/or the time cost is out of concern.

In some embodiments, to generate the first graph representation G_{d} of the dth city, the first graph representation sub-module 310 may normalize an adjacency matrix Ax_{d} of a second graph representation Gx_{d} of the dth city, so as to generate a normalized adjacency matrix A_{d,4}. In some embodiments, the normalized adjacency matrix A_{d,4} may be a stochastic matrix satisfying that the sum of weights of each non-zero row (a row including at least one weight that is not zero) of the adjacency matrix A_{d,4} is equal to 1. Such an adjacency matrix A_{d,4} may describe transition probabilities of the transport activities in the dth city.

The adjacency matrix A_{d,4} may correspond to a graph representation G_{d,4}, which may serve as the first graph representation G_{d} of the dth city or an intermediate graph representation (another second graph representation) of the dth city. The normalization may be performed, for example, when the graph kernel based algorithm adopted in the operation 420 requires to be performed or has a better performance on normalized adjacency matrixes, one or more processing operations in the processing pipeline for generating the first graph representation G_{d} require to be performed on or have a better performance on normalized adjacency matrixes, the result of grouping in the operation 430 is to be optimized, etc. Otherwise, the normalization may be omitted or skipped.

In some embodiments, to generate the first graph representation G_{d} of the dth city, the first graph representation sub-module 310 may convert a directed second graph representation Gx_{d} of the dth city to an undirected graph representation G_{d,s}. In some embodiments, the directed second graph representation Gx_{d} may have a data form of an asymmetric adjacency matrix Ax_{d}, and the undirected graph representation G_{d,5} may have a data form of a symmetric adjacency matrix A_{d,5}. To generate the adjacency matrix A_{d,5}, the first graph representation sub-module 310 may compute a sum Sw_{i,j} of weights w_{i,j} and w_{j,i} of the adjacency matrix Ax_{d}, and set the sum Sw_{i,j} as both of weights w_{i,j}′ and of the adjacency matrix A_{d,5}.

The graph representation G_{d,5} may serve as the first graph representation G_{d} of the dth city or an intermediate graph representation (another second graph representation) of the dth city. The conversion may be performed, for example, when the graph kernel based algorithm adopted in the operation 420 requires to be performed on or has a better performance when treating symmetric adjacency matrixes, while one or more processing operations in the processing pipeline for generating the first graph representation G_{d} require to be performed on or have a better performance on asymmetric adjacency matrixes (e.g., the selection of vertices), etc. Otherwise, the conversion may be omitted or skipped.

It is understood that, the above second graph representation Gx_{d} may be any reasonable one of the graph representations G_{d,0}, G_{d,1}, G_{d,3}, G_{d,4}, and G_{d,5}. The second graph representation Gx_{d} may also be another intermediate graph representation obtained by processing any reasonable one of the graph representations of G_{d,0}, G_{d,1}, G_{d,3}, G_{d,4}, and G_{d,5} via a processing operation not described in the present disclosure. In some embodiments, a processing pipeline for generating the first graph representation G_{d} of the dth city may include a same operation for multiple times. For example, a processing pipeline for generating the first graph representation G_{d} may include two normalization operations, one is for generating an intermediate graph representation upon which a selection of vertices is performed, the other one is for generating the final first graph representation G_{d}.

In some embodiments, the graph kernel based algorithm adopted in the operation 420 may require that the first graph representations of the plurality of cites, e.g., in the form of adjacency matrixes, share the same configuration, then a same process or similar processes may be used for obtaining adjacency matrixes of all the plurality of cities. For example, the graph kernel based algorithm may require that the adjacency matrixes of all the plurality of cites have the same size (e.g., N×N) and vertices represented by the same indexed rows/columns of the adjacency matrixes correspond to the same POI type (i.e., the same mapping function/look-up table is associated with all the adjacency matrixes). Alternatively, the graph kernel based algorithm adopted in the operation 420 may not have such a requirement, and the first graph representations of the plurality of cities may share a same configuration or have different configurations.

In 420, the similarity indicator sub-module 320 may obtain, for any two of the plurality of cities, via a graph kernel based algorithm, a first similarity indicator measuring the similarity between the first graph representations of the any two of the plurality of cities.

The graph kernel based algorithm may involve a kernel (or kernel function) K_{G}. Via the kernel K_{G}, the similarity indicator sub-module 320 may obtain a first similarity indicator s_{x,y} indicating a similarity between the first graph representation Gₓ of the xth city and the first graph representation G_{y} of the yth city in the plurality of cities by:

$${s}_{x , y} = {K}_{G} ( {G}_{x} , {G}_{y} ) , \qquad Function ( 1 )$$

where x and y are integers between 1 and the total number of the plurality of cities (e.g., D). In some embodiments, the first graph representations Gₓ and G_{y} may be in the form of adjacency matrixes. In some embodiments, the mapping functions (if any) of the first graph representations Gₓ and G_{y} for labeling the vertices may also be part of the input of the kernel K_{G}.

By treating the first graph representations of each pair of the plurality of cites with the kernel K_{G}, the similarity indicator sub-module 320 may obtain a plurality of first similarity indicators.

The kernel K_{G} may be a graph kernel, a combination of multiple graph kernels (which may also be referred to as a graph kernel or be referred to as a synthesized graph kernel), or a combination of a graph kernel and a transformation function (e.g., in a nested manner).

In some embodiments, the kernel K_{G} may be a graph kernel based on walks and paths (e.g., a random walk kernel or a variant thereof), a graph kernel based on subtrees, or the like, or a combination thereof. A graph kernel based on walks or paths (e.g., a random walk kernel or a variant thereof, a shortest-paths kernel or a variant thereof) may compare walks or paths in two input graphs, where a walk is a sequence of vertices in a graph that allow repetitions of vertices and a path is a walk that consists of distinct vertices only. For example, a random walk kernel may count all pairs of matching walks in the two input graphs as a metric of the similarity of the two input graphs. A graph kernel based on sub-trees (e.g., a Weisfeiler-Lehman (W-L) kernel) may compare sub-trees of two input graphs, where a sub-tree is a sub-graph that has no cycles (formed by a series of end-to-end connected edges) but a designated root vertex and thus may be seen as a connected subset of distinct vertices of the corresponding graph with an underlying tree structure. For example, a graph kernel based on sub-trees, such as a W-L kernel, may count all pairs of matching sub-trees in the two input graphs as a metric of the similarity of the two input graphs.

It is understood that, any kernel that is based on graph and measures the similarity of two input graphs (e.g., the first graph representations of the plurality of cities) may be used herein to obtain the first similarity indicator. In some embodiments, the input graphs Gₓ and G_{y} may be in the form of adjacency matrixes having the same configuration, and the graph kernel K_{G} may have a form of:

$${K}_{G} ( {G}_{x} , {G}_{y} ) = f ( Σ g ( {w}_{x , i , j} - {w}_{y , i , j} ) ) , \qquad Function ( 2 )$$

where f and g are predetermined functions properly configured so that the kernel K_{G} satisfies standards of a well-defined kernel function (e.g., symmetric (K(Gₓ, G_{y})=K(G_{y}, Gₓ)), positive-semidefinite (p.s.d)), w_{x,i,j} and w_{y,i,j} are corresponding weights in the adjacency matrixes of the input graphs Gₓ and G_{y,} i and j are integers between 1 and the total number of rows/columns of the adjacency matrixes (e.g., N, M, L).

In some embodiments, the kernel K_{G} may be a combination of multiple graph kernels. For instance, the kernel K_{G} may have a form of:

$${K}_{G} ( {G}_{x} , {G}_{y} ) = {α}_{1} {K}_{1} ( {G}_{x} , {G}_{y} ) + {α}_{2} {K}_{3} ( {G}_{x} , {G}_{y} ) + ⋯ + {a}_{Z} {K}_{Z} ( {G}_{x} , {G}_{y} ) , \qquad Function ( 3 )$$

where Z is an integer equal to or more than 2, K₁, K₂, . . . ,K_{Z} are different graph kernels (e.g., a random path kernel, a W-L kernel, a shortest paths kernel, a kernel comply with the Function (2)), and α₁, α₂, . . . , α_{Z} are predetermined coefficients associated with the graph kernels K₁, K₂, . . . , K_{Z}. In some embodiments, α₁+α₂+ . . . +α_{Z}=1. The kernel K_{G} comply with the Function (3) may also be referred to as a graph kernel or be referred to as a synthesized graph kernel.

In some embodiments, the kernel K_{G} may be a combination of a graph kernel and a transformation function. For instance, the kernel K_{G} may have a form of :

$${K}_{G} ( {G}_{x} , {G}_{y} ) = h ( {K}_{G}^{′} ( {G}_{x} , {G}_{y} ) ) , \qquad Function ( 4 )$$

where K′_{G} is a graph kernel (e.g., a synthesized graph kernel or non-synthesized graph kernel), and the function h may be a transformation function selected or determined in accordance with the grouping algorithm adopted in operation 430. The function h may transform the output of the graph kernel K′_{G} into a proper form for the grouping algorithm. For example, the grouping algorithm adopted in operation 430 may require that the value of the first similarity indicators of the plurality of cities within a certain value range (e.g., between 0 and 1), but the output of the graph kernel K′_{G} may be out of such a value range. Then the function h may at least normalize the output of the graph kernel K′_{G} into the value range suitable for the grouping algorithm. As another example, the grouping algorithm adopted in operation 430 may require that the higher the similarity (or the lower the difference) between the first graph representation of two cities, the lower the value of the corresponding first similarity indicator, but the output of the graph kernel K′_{G} may satisfy that, the higher the similarity (or the lower the difference) between the first graph representation of two cities, the higher the value of the corresponding first similarity indicator. The function h may at least convert the output of the graph kernel K′_{G}, so that the generated first similarity indicators may comply with the requirement of the grouping algorithm.

In some embodiments, the similarity indicator sub-module 320 may first use the graph kernel K′_{G} to treat each pair of the plurality of cities to obtain a plurality of outputs, then treat the plurality of outputs with the transformation function h to obtain the plurality of first similarity indicators.

In some embodiments, the kernel K_{G} used to obtain the plurality of first similarity indicators may not be capable of treating graphs with loops. Then in the operation 410, the aforementioned loop removing operation may be performed during the generation of the first graph representations of the plurality of cities. In some embodiments, the kernel K_{G} used to obtain the plurality of first similarity indicators may be capable of treating graphs with loops, then the loop removing operation may be omitted or skipped in the operation 410.

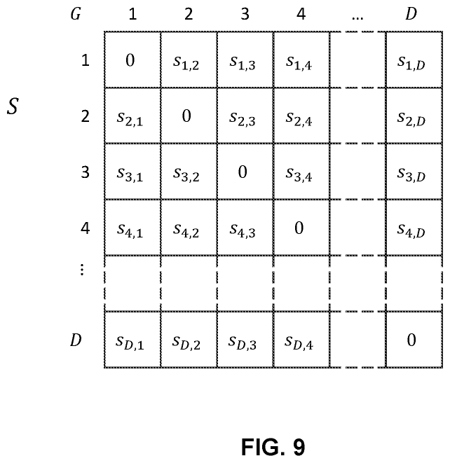

In some embodiments, the similarity indicator sub-module 320 may store the obtained plurality of first similarity indicators in a matrix, which may also have a form of an adjacency matrix. FIG. 9 is a schematic diagram illustrating an exemplary adjacency matrix (matrix S) including the plurality of first similarity indicators according to some embodiments of the present disclosure. As illustrated in FIG. 9, each row/column of the matrix S may represent a city (or a first graph representation thereof) of the plurality of cities (e.g., with a total number of D). A row and a column of the matrix S having the same index number may represent the same city. An element s_{i,j} of the matrix S may be a first similarity indicator indicating a similarity between the first graph representation Gᵢ of the ith city and the first graph representation Gⱼ of the jth city, where i and j are integers between 1 and D. Diagonal elements (e.g., s_{i,i}) of the matrix S may also be obtained using the kernel K_{G}, or be set as a predetermined value (e.g., 0). The matrix S may be subjected to the next operation for grouping the plurality of cities.

In 430, the grouping sub-module 330 may group, based on the first similarity indicators, the plurality of cities into a plurality of city groups.

In some embodiments, the grouping sub-module 330 may use a clustering algorithm as the grouping algorithm to perform the grouping. The grouping sub-module 330 may cluster, based on the first similarity indicators, the plurality of cities via a clustering algorithm to obtain a plurality of clusters, each of which corresponds to one of the plurality of city groups. Various clustering algorithms may be adopted by the grouping sub-module 330. Exemplary clustering algorithm may include a hierarchical cluster analysis, a centroid-based cluster analysis (e.g., K-means or a variant thereof), a graph-based cluster analysis (e.g., a graph community detection), or the like, or a combination thereof. A first similarity indicator obtained in the operation 420 may serve as a metric of “distance” between the corresponding two cities. As used herein, a “distance” between two cities may represent the difference between the first graph representations of the two cities (instead of the geographic distance between the two cities). The higher the difference (or the lower the similarity) between the first graph representations of the corresponding two cities the first similarity indicator indicates, the closer the distance between the two cities is.

For demonstration purposes and simplicity, exemplary clustering algorithms may be described below on the premise that the first similarity indicators obtained in the operation 420 satisfy that, the higher the value of a first similarity indicator is, the higher the difference between the first graph representations of the corresponding two cities. Under such premise, the first similarity indicators may be directly used as the distances between the corresponding two cities. However, it is understood that, the clustering algorithms may also be adjusted to accommodate to other kinds of situations (e.g., the higher the value of a first similarity indicator is, the lower the difference between the first graph representations of the corresponding two cities is).

Hierarchical Cluster Analysis Algorithm

In some embodiments, the grouping sub-module 330 may adopt a hierarchical cluster analysis algorithm to cluster the plurality of cities. The hierarchical cluster analysis algorithm may be agglomerative (e.g., Hierarchical Agglomerative Clustering, HAC) or divisive (e.g., Divisive ANAlysis Clustering, DIANA). In some embodiments, the grouping sub-module 330 adopt an HAC algorithm. Each city of the plurality of cites may be initially treated as an individual cluster. The grouping sub-module 330 may build a hierarchy from the individual clusters by progressively merging clusters having the lowest distance. To obtain a distance between two clusters, the grouping sub-module 330 may use a complete-linkage approach (i.e., the maximum distance between cities of the two clusters), a single-linkage approach (i.e., the minimum distance between cities of the two clusters), or an average-linkage approach (i.e., the mean distance between cities of the two clusters).

FIG. 10 is a schematic diagram illustrating an exemplary hierarchical agglomerative clustering algorithm (HAC) according to some embodiments of the present disclosure. For demonstration purposes and not intended to be limiting, only seven cities (Cities 1-7) are illustrated in FIG. 10. Initially, each of the seven cities may be treated as an individual cluster, thus a total of seven clusters may be formed. The merging of clusters may be performed for six stages in a “bottom up” manner to generate a hierarchy 1000 as illustrated in FIG. 10. At the first stage, the grouping sub-module 330 may merge the clusters {City 3} and {City 4} to form a new cluster {City 3, City 4} as these two clusters have the lowest distance. At the second stage, the grouping sub-module 330 may merge the clusters {City 5} and {City 6} to form a new cluster {City 5, City 6} as these two clusters have the lowest distance. Similarly, the grouping sub-module 330 may sequentially form the clusters {City 1, City 2}, {City 1, City 2, City 3, City 4}, {City 5, City 6, City 7}, and finally the cluster {City 1, City 2, City 3, City 4, City 5, City 6, City 7} including all the cities.

The grouping sub-module 330 may analyze the hierarchy 1000 to identify the best stage and choose the clusters obtained at that stage as the plurality of city groups. For example, the grouping sub-module 330 may identify the fourth stage is the best stage, then determine the corresponding clusters {City 1, City 2, City 3, City 4}, {City 5, City 6} and {City 7} as the plurality of city groups. The metric for the grouping sub-module 330 to identify the best stage may be or be based on, for example, the within-class distances of the corresponding clusters, the between-class distances between any two of the corresponding clusters, the number of the corresponding clusters, the numbers of cities of the corresponding clusters, or the like, or a combination thereof.

In some embodiments, the grouping sub-module 330 may not build the whole hierarchy. The merging of the clusters may be performed until a termination condition is met. Exemplary termination conditions may include: the number of the clusters is below a threshold, the obtained shortest distance is above a threshold, the number of cities in the cluster formed or to be formed is above a threshold, or the like, or a combination thereof. Upon a detection that a termination condition is met, the grouping sub-module 330 may stop the clustering, and output the current clusters as the plurality of city groups.

In some embodiments, the HAC algorithm may be performed on the matrix S obtained in the operation 420. As the clustering progresses, rows and columns of the matrix S may be merged as the clusters are merged, and the distances in the matrix S may be updated accordingly.

In some embodiments, the grouping sub-module 330 may adopt a DIANA algorithm. Initially, all of the plurality of cites may be treated as a global cluster. The grouping sub-module 330 may build a hierarchy from the global cluster by progressively split a current cluster into two clusters having the farthest distance in a “top down” manner. The DIANA algorithm may be regarded as a reverse form of the HAC algorithm.

Variants of the HAC algorithm or DIANA algorithm may also be adopted by the grouping sub-module 330.

Graph Community Detection Algorithm

In some embodiments, the grouping sub-module 330 may adopt a graph community detection algorithm or a variant thereof to cluster the plurality of cities. It is understood that, the matrix S obtained in the operation 420 may also have a form of an undirected graph. The vertices of the graph may represent cities of the plurality of cities, and the first similarity indicators in the matrix S may be weights associated with the corresponding edges. The graph community detection algorithm may be performed on such a matrix S.

The graph community detection algorithm may be similar to the HAC algorithm described above, but with a different criteria to select clusters to be merged. Also, to adopt the graph community detection algorithm, in some embodiments, the first similarity indicators in the matrix S may satisfy that, the higher the value of a first similarity indicator is, the higher the similarity between the first graph representations of the corresponding cities is. It is understood that, the graph community detection algorithm may also be adjusted to accommodate to other kinds of situations.

In some embodiments, the s_{i,j} in the matrix S may be between 0 and 1. The similarity indicator sub-module 320 may normalize the output of the graph kernel to such a range.

In the graph community detection algorithm, each city of the plurality of cites (or each vertex of the graph) may also be initially treated as an individual cluster. The grouping sub-module 330 may also build a hierarchy from the individual clusters by progressively merging clusters in a “bottom up” manner. However, to select the clusters to be merged, the grouping sub-module 330 may try to merge any two clusters connected by a single edge and compute the gaining of the modularity of the whole graph caused by the merging. The grouping sub-module 330 may select two clusters corresponding to the maximum gaining of the modularity as the clusters to be merged.

In some embodiments, the modularity MOD of the graph may be computed by:

$$MOD = \frac{1}{2 H} {\sum }_{i , j = 1}^{D} ( {s}_{i , j} - \frac{{sk}_{i} {sk}_{j}}{2 H} ) δ ( {c}_{i} , {c}_{j} ) , \qquad Function ( 5 )$$

where H is the sum of all the first similarity indicators in the matrix S, s_{i,j} is the first similarity indicator for the ith city (or vertex) and the jth city, i and j are integers between 1 and D, D is the total number of the plurality of cities, Skᵢ and Skⱼ are respectively the sums of the first similarity indicators in the ith row/column and jth row/column of the matrix S, cᵢ and cⱼ are respectively the clusters of the ith city and the jth city, the function δ may be a Kronecker-delta function which may return 1 when cᵢ=cⱼ and return 0 when cᵢ≠cⱼ. The grouping sub-module 330 may obtain the gaining of the modularity by subtracting the modularity of the graph before the merging from the modularity of the graph after the merging.

K-Means Algorithm

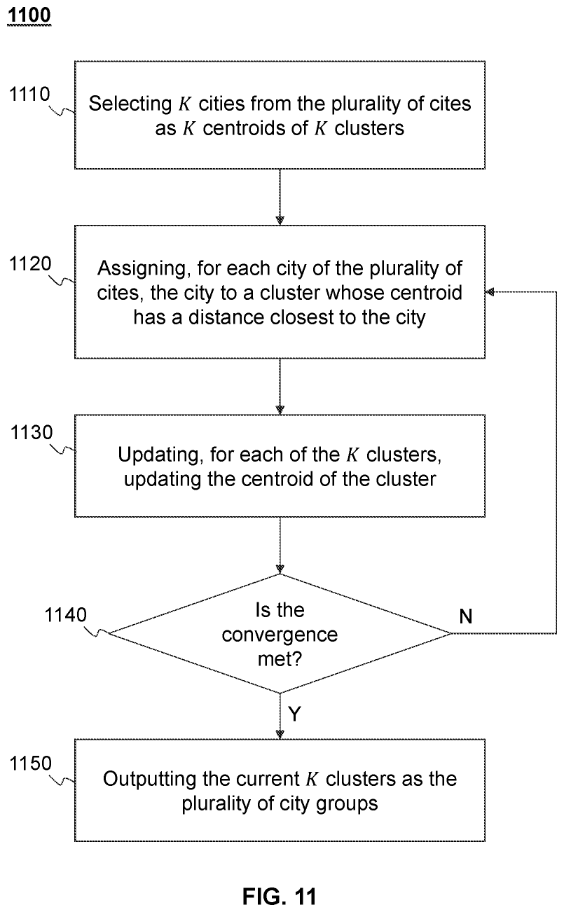

In some embodiments, the grouping sub-module 330 may adopt a K-means algorithm or a variant thereof to cluster the plurality of cities. Via the K-means algorithm, the grouping sub-module 330 may cluster the plurality of cities into K clusters via a process illustrated in FIG. 11.

FIG. 11 is a flowchart illustrating an exemplary clustering process (process 1100) according to some embodiments of the present disclosure.

In 1110, the grouping sub-module 330 may select K cities from the plurality of cites as centroids of K clusters, where K is an integer equal to or more than 2. The selection may be performed randomly or according to a predetermined manner to optimize the result (e.g., K-means++). K may be a predetermined number or be adaptively determined by the grouping sub-module 330 based on the first similarity indicators obtained in the operation 420.

Operations 1120-1140 may be performed iteratively.

In 1120, the grouping sub-module 330 may assign, for each city of the plurality of cities, the city to a cluster whose centroid has a distance lowest to the city. The grouping sub-module 330 may identify the maximum first similarity indicator from the first similarity indicators between the city and the centroids of the K clusters, and assign the city to the cluster corresponding to the maximum first similarity indicator.

In 1130, the grouping sub-module 330 may update, for each of the K clusters, the centroid of the cluster.

In 1140, the grouping sub-module 330 may detect whether a convergence is met (e.g., using the Cauchy Criterion: the changes (e.g., in the form of distances between the centroids of the last iteration and the corresponding centroids determined in the current iteration) of all (or at least most) of the centroids are less than a pre-determined threshold compared with the centroids determined in the last iteration in the operation 1130). Upon a detection the convergence is not met, the grouping sub-module 330 may re-perform the operation 1120 to initiate the next iteration and re-cluster the plurality of cities into K clusters using the K updated centroids. Upon a detection that the convergence is met, the grouping sub-module 330 may perform operation 1150, in which the grouping sub-module 330 may output the current K clusters as the plurality of city groups.

In some embodiments, in the operation 1130, to update the centroid of a cluster of the K clusters, the grouping sub-module 330 may compute a mean G̅ of the first graph representations (e.g., in the form of adjacency matrixes) of the cities in the same cluster as the updated centroid. Then in the operation 1120 of the next iteration, for each city of the plurality of cities, the grouping sub-module 330 may compute a distance from the city to each of the K updated centroids by using the kernel K_{G} to treat the first graph representation of the city and the corresponding G̅, and assign the city to a cluster whose centroid has a distance lowest to the city.

It is understood that, the grouping sub-module 330 may also use other clustering algorithms or a variant thereof to group the plurality of cities into the plurality of city groups, such as a clustering algorithm based on unsupervised machine learning algorithm.

In some embodiments, the operation 420 and the operation 430 may be combined. Correspondingly, the similarity indicator sub-module 320 may be integrated into the grouping sub-module 330. For example, during the grouping process, whenever the grouping sub-module 330 is to determine an unknown distance between a first city and a second city, the grouping sub-module may obtain a corresponding first similarity indicator as the distance with the graph kernel K_{G} in real-time. It is not necessary to obtain all the first similarity indicators before the grouping.

Referring back to FIG. 4. In 440, the transportation type identification sub-module 340 may identify, for each of the plurality of city groups, at least one featured transportation type of the city group. For example, the transportation type identification sub-module 340 may determine a featured distribution of transportation types of the cities in a city group, and identify the at least one featured transportation type of the city group based on the featured distribution (e.g., by ranking).

In some embodiments, for each of the plurality of city groups, the transportation type identification sub-module 340 may obtain a first featured graph representation of the city group, and obtain the featured distribution of transportation types of the city group based on the first featured graph representation.

In some embodiments, the transportation type identification sub-module 340 may obtain the first graph representation of a city that is the centroid city of a city group as the first featured graph representation of the city group. For example, the operation 430 may be performed via a K-means clustering algorithm, and the finally determined centroids may be the centroids of the city groups. As another example, the operation 430 may be performed using another clustering algorithm (e.g., HAC), and the transportation type identification sub-module 340 may identify, for each of the plurality of city groups, a city in the city group having the lowest mean (or sum, median, mode) of distances (e.g., the first similarity indicators) to other cities in the same city group as the centroid of the city group.

In some embodiments, the transportation type identification sub-module 340 may obtain the mean (or median, mode) of the first graph representations (e.g., in the form of adjacency matrixes) of all the cities in a city group as the first featured graph representation of the city group.

In some embodiments, the transportation type identification sub-module 340 may select a plurality of vertices from the first graph representation of the centroid of a city group or the mean of the first graph representations of all the cities in the city group to form the first featured graph representation of the city group. For example, the transportation type identification sub-module 340 may select the plurality of vertices by ranking the vertices of the first graph representation of the centroid of the city group or the mean of the first graph representations of all the cities in the city group in view of their importance (or contributions) to the transport activities. The selection of the plurality of vertices and the forming of the first featured graph representation may be the same as or similar to the process for generating the adjacency matrix A_{d,3} in the operation 410, the descriptions of which is not repeated herein.

The transportation type identification sub-module 340 may identify and quantify a plurality of transportation types based on the first featured graph representation to form the featured distribution. To quantify a transportation type, the transportation type identification sub-module 340 may obtain a quantified number based at least on weights of one or more edges associated with the transportation type and associate the quantified number to the transportation type.

For example, the first featured graph representation may include a plurality vertices representing different POI types and a plurality of edges (directed or undirected) representing transport activities between POIs of the corresponding POI types. The transportation type identification sub-module 340 may identify a transportation type in the first featured graph representation according to an edge and/or a vertex of the first featured graph representation.

Obviously, a single edge (directed or undirected) of the first featured graph representation may be used to define a transportation type (or be referred to as a second-order transportation type). For example, an edge connecting a first vertex corresponding to a residential district POI type or home POI type and a second vertex corresponding to an industrial district POI type or work POI type may represent a type of transport activities related to commute.

In some embodiments, a second-order transportation type may be quantified by a weight associated with the corresponding edge.

In some embodiments, directed edges connecting the same pair of vertices may also define a second-order transportation type, and such a second-order transportation type may be quantified by a sum of weights associated with the directed edges.

In different embodiments, the transportation type identification sub-module 340 may identify a total of one (minimum) to three (maximum) second-order transportation types for a pair of directed edges connecting the same pair of vertices.

In some embodiments, a single vertex may be used to define one or more transportation types (or be referred to a first-order transportation type), as the vertex itself may represent a type of transport activities starting from and/or ending at POIs associated with the vertex. For example, a vertex corresponding to an entertainment POI type may represent a type of transport activities related to entertainment.

In some embodiments, the first featured graph representation may be undirected. One vertex may correspond to one first-order transportation type, and a first-order transportation type may be quantified by a sum of weights of all the edges connecting to the corresponding vertex (e.g., weights in the corresponding row/column of the corresponding adjacency matrix).

In some embodiments, the first featured graph representation may be directed. One vertex may correspond to two first-order transportation types, which correspond to transport activities starting from and ending at the associated POIs, respectively. Such a first-order transportation type may be quantified by a sum of weights of all the edges starting from the corresponding vertex e.g., weights in the corresponding row of the corresponding adjacency matrix) or a sum of weights of all the edges ending at the corresponding vertex (e.g., weights in the corresponding column of the corresponding adjacency matrix). In some embodiments, the first featured graph representation may be directed, but one vertex can still correspond to one first-order transportation type. Such a first-order transportation type may be quantified by a sum of weights of all the edges starting from and ending at the corresponding vertex (e.g., weights in the corresponding row and the corresponding column of the corresponding adjacency matrix).

In different embodiments, when the first featured graph representation is directed, the transportation type identification sub-module 340 may identify a total of one (minimum) to three (maximum) first-order transportation types for a vertex when there are edges starting from and ending at the vertex.

The transportation type identification sub-module 340 may identify and quantify all the possible second-order transportation types and/or all the possible first-order transportation types from the first featured graph representation of the city group, and thereby to form a featured distribution of transportation types for the city group. A larger quantified number may represent a higher importance (or contribution), while a smaller quantified number may represent a lower importance (or contribution) By ranking the transportation types based on the quantified numbers of the transportation types, the transportation type identification sub-module 340 may identify the at least one featured transportation type of the city group. For example, the at least one featured transportation type may include one or more transportation types having the largest quantified numbers and/or one or more transportation types having the smallest quantified numbers.

In some embodiments, the generation of the featured distribution of the transportation types may involve both the second-order transportation types and the first-order transportation types. The featured distribution of transportation types of a city group may differentiate the first-order transportation types from the second-order transportation types. For example, the featured distribution of transportation types may include a distribution of the first-order transportation types and a distribution of the second-order transportation types as two distinctive parts. Alternatively, the featured distribution of transportation types of a city group may not differentiate the first-order transportation types from the second-order transportation types. For example, the first-order transportation types and the second-order transportation types may be mixed in the featured distribution.

In some embodiments, the transportation type identification sub-module 340 may perform a single ranking process for both the first-order transportation types and the second order transportation types.

In some embodiments, the transportation type identification sub-module 340 may perform a first ranking on the first-order transportation types and a second ranking on the second-order transportation types respectively. The at least one featured transportation type may include one or more first-order transportation types selected based on the first ranking and one or more second-order transportation types selected based on the second ranking.

In operation 450, the strategy sub-module 360 may associate, for each of the plurality of city groups, a strategy to the city group for managing transportation of cites belonging to the city group. In some embodiments, a strategy associated with a city group may promote or restrict the at least one featured transportation type of the city group. A strategy may take various forms in different application scenarios. Exemplary scenarios are described below, which are for demonstration purposes only and not intended to be limiting.

In some embodiments, the transportation analysis module 300 may be included in a navigation system. A strategy associated with a city group may be in the form of, for example, a model involved for planning routes or one or more parameters to be inputted into such a model. For example, the strategy may cause that, when determining routes in a city of the corresponding city group, the determined routes may avoid roads possibly to be occupied (which may not be the current situation) by transport activities of one or more featured transportation types having larger quantified numbers and/or along roads possibly to be occupied by transport activities of one or more featured transportation types having smaller quantified numbers. As another example, the strategy may cause that, when a user sends a request via a computing device (e.g., a mobile phone) to determine a route corresponding to a featured transportation type having a large quantified number, the computing device warns the user with possible traffic jam and/or resource occupation, and/or suggesting a more proper time for performing the transportation.

In some embodiments, the transportation analysis module 300 may be included in an online-to-offline transportation service platform system. A strategy associated with a city group may be in the form of, for example, a model involved for distributing orders, a model involved for regulating behaviors (e.g., by providing or adjusting fee or share) of a user or a transportation service provider, or one or more parameters to be inputted into the above models. For example, the strategy may cause a transportation service provider to accept more orders corresponding to featured transportation types whose quantified number is larger (e.g., by increasing share) and/or accept fewer orders corresponding to featured transportation types whose quantified number is smaller (e.g., by decreasing share).

In some embodiments, the operation 450 may be skipped or omitted. The transportation analysis module 300, or the report sub-module 370, may output a report presenting the featured transportation types and/or the featured distribution of transportation types of one or more of the plurality of the city group. The report may include one or more texts, charts, animations, and/or videos for presenting its content. The transportation analysis module 330 may output the generated report, and present the report via a display device.

In some embodiments, the transportation analysis module 300, or the classifier sub-module 380, may generate a classifier for classifying an unknown city (a city not included in the plurality of cites being clustered) using the result of the cluster analysis in the operation 430. The plurality of clusters obtained via the operation 430 may serve as the plurality of city groups a city of interest to be classified into.

In some embodiments, to generate the classifier, the classifier sub-module 350 may obtain, for each of the plurality of city groups, a second featured graph representation of the city group via one of the exemplary approaches for generating the first featured graph representation described in the operation 440. In some embodiments, the second featured graph representation and the first featured graph representation may be generated via the same approach. The generated classifier may be configured to obtain, for each of the second featured graph representations, a second similarity indicator indicating the similarity between the graph representation of the city of interest and the second featured graph representation. The classifier may also be configured to classify the city of interest into a city group corresponding to a second similarity indicator indicating the highest similarity (e.g., has the highest value). A second similarity indicator may be obtained by using the graph kernel K_{G} to treat the graph representation of the city of interest and the corresponding second featured graph.

In some embodiments, the classifier sub-module 380 may label the plurality of cities (or the first graph representations thereof) according to their clusters. The first graph representations of the plurality of cites (e.g., in the form adjacency matrixes of the same configuration) and the corresponding labels may serve as a training dataset for training the classifier. Alternatively, the transportation data associated with the plurality of cities and the corresponding labels may server as a training dataset for training the classifier. The classifier sub-module 380 may train the classifier using a machine-learning algorithm with the training dataset. In different embodiments, the classifier may be or may include a decision tree (or a plurality of decision trees such as a random-forests classifier), a support vector machine (SVM), a neural network (e.g., a convolutional neural network), or the like, or a combination thereof.

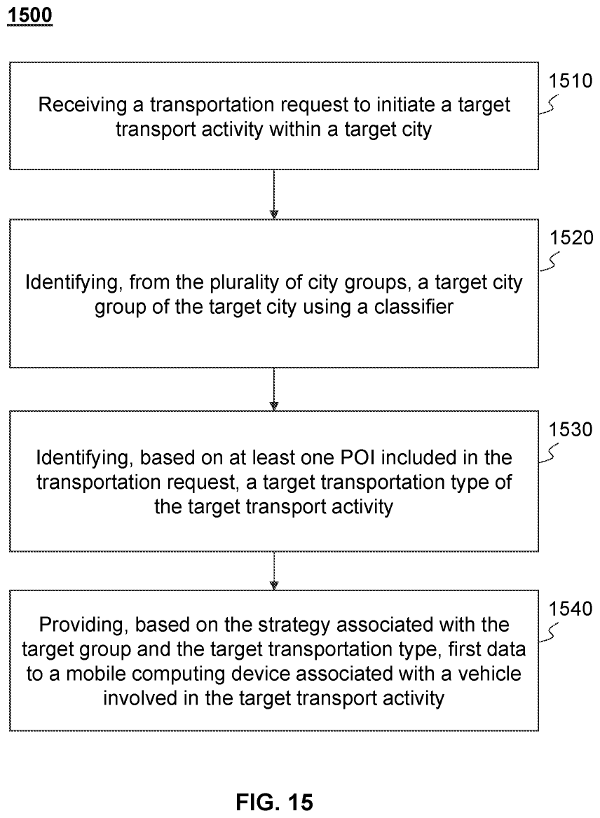

The generated classifier may be used in a process illustrated in FIG. 15 for identifying a city group (or a label) of a target city from the plurality of city groups and manage the transportation of the target city using the strategy associated with the city group.

It should be noted that the above descriptions of the process 400 are only for demonstration purposes, and not intended to limit the scope of the present disclosure. It is understandable that, after learning the major concept of the present disclosure, a person of ordinary skill in the art may alter the process 400 in an uncreative manner. For example, the operations above may be implemented in an order different from that illustrated in FIG. 4. One or more optional operations may be added to the flowcharts. One or more operations may be split or be combined. All such modifications are within the scope of the present disclosure.

FIG. 12 is a schematic diagram illustrating an exemplary first graph representation sub-module (first graph representation sub-module 1200) according to some embodiments of the present disclosure. The first graph representation sub-module 1200 may be implemented by the server 110 to generate a first graph representation of a city via a process illustrated in FIG. 13 or an embodiment thereof. The first graph representation sub-module 1200 may include a second graph representation unit 1210, a score associating unit 1220, a score updating unit 1230, a vertex selection unit 1240, and a first graph representation unit 1250.

The second graph representation unit 1210 may generate, for each of the plurality of cities, a second graph representation based on transportation data relating to transport activities within the city. The second graph representation may include a plurality of vertices and a plurality of edges.

The score associating unit 1220 may associate a score with each vertex of the second graph representation.

The score updating unit 1230 may iteratively update, for each vertex of the second graph representation, the score associated with the vertex at least based on scores of one or more neighbor vertices of the vertex and weights of one or more edges through which the one or more neighbor vertices connecting to the vertex.

The vertex selection unit 1240 may select vertices based on the scores of the vertices of the second graph representation.

The first graph representation unit 1250 may generate the first graph representation using the selected vertices.

The functions and operations of the units of the first graph representation sub-module 1200 may be further described in connection with FIG. 13.

It may be noted that, the above descriptions about the first graph representation sub-module 1200 are only for illustration purposes, and not intended to limit the present disclosure. It is understood that, after learning the major concept and the mechanism of the present disclosure, a person of ordinary skill in the art may alter the first graph representation sub-module 1200 in an uncreative manner. The alteration may include combining and/or splitting units, adding or removing optional units. All such modifications are within the protection scope of the present disclosure.

FIG. 13 is a flowchart illustrating an exemplary process (process 1300) for generating a first graph representation of a city according to some embodiments of the present disclosure. The process 1300 may be performed by the first graph representation sub-module 1200 to generate a first graph representation of a city, such as the dth city of the plurality of cities described in the operation 410 of the process 400 illustrated in FIG. 4. By repeating the process 1300, the first graph representations of all the plurality of cities may be obtained and then subjected to the operation 420 of the process 400.

In some embodiments, one or more operations of the process 1300 illustrated in FIG. 13 may be implemented in the system 100 illustrated in FIG. 1. For example, the process 1300 illustrated in FIG. 13 may be stored in a storage device (e.g., the RAM 240, the storage device 220) in the form of instructions, and invoked and/or executed by one or more processors (e.g., the processor 210) implementing the corresponding units of the first graph representation sub-module 1200.

The process 1300 may involve generating a second graph representation (i.e., the aforementioned original graph representation or intermediate graph representation) of the dth city and generating the first graph representation of the dth city based on the second graph representation. For simplicity, a vertex of a first graph representation may be referred to as a first vertex, an edge of a first graph representation may be referred to as a first edge, a vertex of a second graph representation may be referred to as a second vertex, and an edge of a second graph representation may be referred to as a second edge.

In 1310, the second graph representation unit 1210 may generate, based on transportation data associated with the dth city of the plurality of cities, a second graph representation Gx_{d} including N second vertices and a plurality of second edges, where N is an integer above 2, and d is an integer between 1 and N.

In some embodiments, the data form of the second graph representation Gx_{d} may be an adjacency matrix Ax_{d} having a size of N×N.

In some embodiments, the adjacency matrix Ax_{d} may be a stochastic matrix satisfying that the sum of weights of each non-zero row of the adjacency matrix Ax_{d} is equal to 1. The adjacency matrix Ax_{d} may describe transition probabilities of the transport activities in the dth city. When the adjacency matrix Ax_{d} is not a stochastic matrix, the second graph representation unit 1210 may normalize the adjacency matrix Ax_{d} to obtain a corresponding stochastic matrix.

For descriptions of generating the adjacency matrix Ax_{d}, reference may be made to the operation 410 of the process 400. In some embodiments, to generate the adjacency matrix Ax_{d} which is also a stochastic matrix, the second graph representation unit 1210 may first generate an adjacency matrix A_{d,0} based on the transportation data associated with the dth city, then perform a loop removing operation on the adjacency matrix A_{d,0} to generate an adjacency matrix A_{d,1} (or A_{d,2}), and next normalize the adjacency matrix A_{d,1} (or A_{d,2}) to generate the adjacency matrix Ax_{d} to be used in the current operation. Detailed descriptions of the above process may be found in the descriptions of the operation 410, which are not repeated herein.

In 1315, the score associating unit 1220 may associate a score with each second vertex of the second graph representation Gx_{d}. The score initially associated with each second vertex may be a predetermined non-zero number (e.g., 1, 0.5, 0.2), a random number, a predetermined number associated with the corresponding POI type, a number determined based on properties of elements of the second graph representation Gx_{d}, a number determined based on a priori model, or the like, or a combination thereof.

In some embodiments, the score initially associated with each second vertex may be a predetermined number, such as 1, 0.5, 0.2, 0.1, etc.

In some embodiments, the score initially associated with each second vertex may be 1/N.

In some embodiments, the initial score associated with each second vertex may be based on the number of edges (or the sum of weights of the edges) starting from and/or ending at the second vertex. For example, the score associated with an a second vertex may be a ratio of the number of second edges starting from and/or ending at the second vertex to the number of all the second edges of the second graph representation Gx_{d}. As another example, the score may be a ratio of the sum of weights of second edges starting from and/or ending at the second vertex to the sum of weights of all the second edges of the second graph representation Gx_{d}.

Via operations 1320 to operations 1355, the score updating unit 1230 may iteratively update the score associated with each second vertex of the second graph representation Gx_{d}.

In 1320, the score updating unit 1230 may set i=1 to focus on the first second vertex V₁ of the second graph representation Gx_{d}. During the process 1300, the score updating unit 1230 may set i with an integer in a range of [1,D] to focus on different vertex of the second graph representation Gx_{d}.

In 1325, the score updating unit 1230 may identify one or more neighbor vertices of the ith second vertex Vᵢ of the second graph representation Gx_{d}. A neighbor vertex of the second vertex Vᵢ may be a second vertex from which the second vertex Vᵢ may be reachable via a single second edge (directed or undirected). When the second graph representation Gx_{d} is an undirected graph, a neighbor vertex may be any second vertex connecting with the second vertex Vᵢ through a single second edge. When the second graph representation Gx_{d} is a directed graph, a neighbor vertex may be a second vertex from which a directed edge points to the second vertex Vᵢ. For example, as illustrated in FIG. 7, when the directed edge 725 does not exist, the vertex 710 is a neighbor vertex of the vertex 715, but the vertex 715 is not a neighbor vertex of the vertex 710.

In some embodiments, the score updating unit 1230 may identify the one or more neighbor vertices of the ith second vertex Vᵢ by detecting non-zero weights in the ith column of the adjacency matrix Ax_{d} (or in the ith row if the second graph representation Gx_{d} is undirected). The row of a detected non-zero weight may correspond to a neighbor vertex of the ith second vertex Vᵢ.

In 1330, the score updating unit 1230 may obtain scores of the one or more neighbor vertices of the second vertex Vᵢ identified in the operation 1325.

In 1335, the score updating unit 1230 may obtain weights of one or more second edges through which the one or more neighbor vertices connecting to the second vertex Vᵢ.

In some embodiments, the weights of the one or more second edges may be the non-zero weight(s) detected in the operation 1325.

In operation 1340, the score updating unit 1230 may update, based on the scores of the one or more neighbor vertices and the weights of the one or more second edges, the score of the second vertex Vᵢ.

In some embodiments, the updating may be performed in view of a probability that the POIs associated with the second vertex Vᵢ serve as destinations of the transport activities in the dth city. In some embodiments, the score updating unit 1230 may update the score SVᵢ associated with the second vertex Vᵢ by:

$${SV}_{i} = {Σ}_{v ∈ NV} \frac{{SV}_{v}}{{SL}_{v}} , \qquad Function ( 6 )$$

where NV is a set constituted of the one or more neighbor vertices of the second vertex Vᵢ, v is a vertex in the set NV, SVᵥ is the score associated with the vertex v. SLᵥ is the sum of weights of all the second edges starting from the vertex v (or the weight of the only second edge starting from the vertex v) when the second graph representation Gx_{d} is a directed graph, or the sum of weights of all the second edges connecting with the vertex v when the second graph representation Gx_{d} is an undirected graph.

In some embodiments, the score updating unit 1230 may update the score SVᵢ based further on a factor pf, which represents a probability that a vehicle to engage a second transportation after completing a first transportation within a predetermined time window (e.g., 10 min, 30 min, 1 h, 4 h, 8 h, 1d). In some embodiments, the factor pf may be introduced into the Function (6) by:

$${SV}_{i} = ( 1 - pf ) \times \frac{Ss}{N} + pf \times ( {Σ}_{v ∈ NV} \frac{{SV}_{v}}{{SL}_{v}} ) , \qquad Function ( 7 )$$

where Ss is the sum of the scores initially associated the N second vertices. In some embodiments, Ss may be equal to 1 or N.

In some embodiments, the factor pf may have a value range of [0.1, 1]. In some embodiments, the factor pf may have a value range of [0.5, 0.85].

By iteratively updating the score associated with each vertex of the second graph representation via the Function (6) or the Function (7), a second vertex (or the corresponding POI type) associated with POIs having higher probabilities to serve as destinations of the transport activities in the dth city may be associated with a higher score. Such a score may serve as a metric of importance of the corresponding second vertex.

In 1345, the score updating unit 1230 may detect that whether the updating of scores in the current iteration is completed by checking, for example, whether i<D. Upon a detection that i<D, the score updating unit 1230 may trigger operation 1350 to focus on the i+1th vertex of the second graph representation Gx_{d}, and perform the operations 1325 to 1345 on the i+1th vertex to update the score SVᵢ₊₁ of the i+1th vertex. Upon a detection that i≥D, the score updating unit 1230 may trigger operation 1355 to detect whether a termination condition for terminating the updating of scores is satisfied. Exemplary termination conditions for terminating the updating of scores may include: a convergence is met, a count of iterations is equal to or above a predetermined number, or the like, or a combination thereof. Upon a detection that the termination condition is not satisfied, the score updating unit 1230 may start the next iteration for updating the scores and re-trigger the operation 1320 to focus on the first second vertex V₁ again. Upon a detection that a termination condition is satisfied, the score updating unit 1230 may end the updating, and operation 1360 may be triggered.

The operations 1325 to 1355 may be performed in any proper sequence. For example, the operation 1335 may be performed before the operation 1330. As another example, the operation 1345 and/or the operation 1355 may be performed before the operation 1325, and the operation 1350 may be performed right after the operation 1340 and before the operation 1345 of the next iteration. In some embodiments, two or more of the operations 1325 to 1355 may be integrated into a single operation. For example, the operations 1325, 1330, 1335, and 1340 may be integrated into a single operation.

In 1360, the vertex selection unit 1240 may select L vertices from the N second vertices based on the scores of the N second vertices, where L may be an integer between 2 and N. L may be a predetermined integer (e.g., 10, 15, 20) or depend on the scores of the N second vertices. For example, the vertex selection unit 1240 may select the L vertices by ranking the plurality of second vertices based on the scores thereof. The selected vertices may be the L vertices with the highest scores. Alternatively, the vertex selection unit 1240 may select vertices whose score is within a predetermined value range (e.g., above a threshold) as the L vertices.

In 1365, the first graph representation unit 1250 may generate the first graph representation G_{d} of the dth city using the L selected vertices. The L selected vertices may serve as the first vertices of the first graph representation.

In some embodiments, the first graph representation unit 1250 may generate an adjacency matrix A_{d,3} using the L selected vertices via operations described in connection with the operation 410, which are not repeated herein. The adjacency matrix A_{d,3} may directly serve as the first graph representation G_{d} of the dth city. Alternatively, the first graph representation unit 1250 may further process the adjacency matrix A_{d,3} to generate the first graph representation G_{d}.

In some embodiments, the adjacency matrix Ax_{d} of the second graph representation Gx_{d} may be a stochastic matrix, and the sum of weights in each non-zero row of the corresponding adjacency matrix Ax_{d} may be equal to 1. Let SV be a vector in the form of [SV₁, SV₂, . . . , SV_{N}]^{T}, where SV₁, SV₂, . . . , SV_{N} are scores of the 1st second vertex, the 2nd second vertex, . . . , and the Nth second vertex of the second graph representation Gx_{d}. The vector SV may be obtained as an eigenvector of the matrix Ax_{d}^{T}, which is the transpose of the adjacency matrix Ax_{d}. The first graph representation sub-module 1200, or a unit (e.g., a computation unit) to replace the score associating unit 1220 and the score updating unit 1230, may obtain the vector SV by solving:

$${Ax}_{d}^{T} SV = λ SV , \qquad Function ( 8 )$$

where is an eigenvalue of the matrix Ax_{d}^{T}. λ may be equal to 1 in some embodiments.

In some embodiments, the adjacency matrix Ax_{d} of the second graph representation Gx_{d} may not be a stochastic matrix. Then the first graph representation sub-module 1200, or the second graph representation unit 1210, may normalize the adjacency matrix Ax_{d} to generate a stochastic matrix, which may then be used to obtain the vector SV via the Function (8).

In some embodiments, the second graph representation Gx_{d} may be undirected, then the adjacency matrix Ax_{d} may be symmetric, and AX_{d}^{T}=Ax_{d}. Correspondingly, the vector SV may be an eigenvector of the adjacency matrix Ax_{d}. The first graph representation sub-module 1200, or the computation unit, may calculate an eigenvector of the adjacency matrix Ax_{d} as the vector SV.

The vector SV, or the scores of the N second vertices included in the vector SV, may then be used in the operation 1360 for selecting the L vertices.

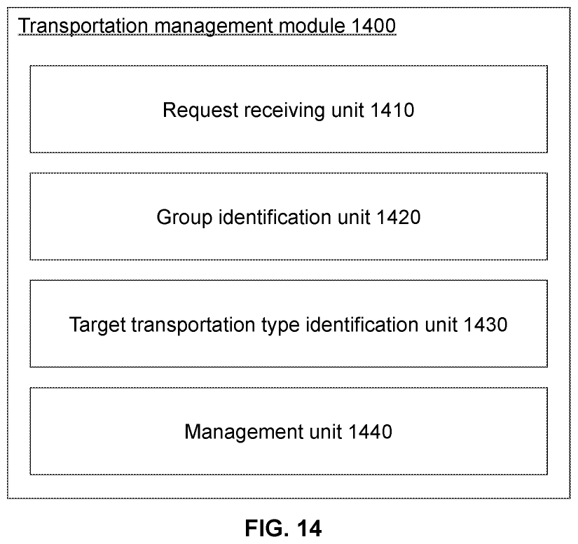

FIG. 14 is a schematic diagram illustrating an exemplary transportation management module (transportation management module 1400) according to some embodiments of the present disclosure. The transportation management module 1400 may be implemented by the server 110 to manage transportation of a city via a process illustrated in FIG. 15 or an embodiment thereof. The transportation management module 1400 may include a request receiving unit 1410, a group identification unit 1420, and a management unit 1430.

The request receiving unit 1410 may receive a transportation request to initiate a target transport activity within a target city.

The group identification unit 1420 may identify, from the plurality of city groups, a target city group of the target city using a classifier. The classifier may be obtained based on the result of the grouping in the operation 430.

The target transportation type identification unit 1430 may identify, based on at least one POI included in the transportation request, a target transportation type of the target transport activity.

The management unit 1440 may provide, based on the strategy associated with the target group and the target transportation type, first data to a mobile computing device associated with a vehicle involved in the target transport activity, causing the vehicle to more frequently or less frequently engage in transport activities of the target transportation type.

The functions and operations of the sub-modules of the transportation management module 1400 may be further described in connection with FIG. 15.

It may be noted that, the above descriptions about the transportation management module 1400 are only for illustration purposes, and not intended to limit the present disclosure. It is understood that, after learning the major concept and the mechanism of the present disclosure, a person of ordinary skill in the art may alter the transportation management module 1400 in an uncreative manner. The alteration may include combining and/or splitting unit, adding or removing optional units, etc. All such modifications are within the protection scope of the present disclosure.

FIG. 15 is a flowchart illustrating an exemplary transportation management process (process 1500) according to some embodiments of the present disclosure. The process 1500 may be performed by the transportation management module 1400 to manage transportation of different cities. In some embodiments, one or more operations of the process 1500 illustrated in FIG. 15 may be implemented in the system 100 illustrated in FIG. 1. For example, the process 1500 illustrated in FIG. 15 may be stored in a storage device (e.g., the RAM 240, the storage device 220) in the form of instructions, and invoked and/or executed by one or more processors (e.g., the processor 210) implementing the corresponding sub-modules of the transportation management module 1400.

In some embodiments, the system 100 for performing the process 1500 may implement an online-to-offline transportation service platform. A passenger may send a transportation request via the online-to-offline driving service platform for ordering a transportation service. A transportation service provider such as a human driver or an unmanned vehicle may accept the transportation request via the platform and provide the required transportation service to the passenger. Via the process 1500, the transportation services provided via the platform may be managed or be regulated so as to improve the service quality of the platform and/or improve the transportation state of different cities.

In 1510, the request receiving unit 1410 may receive a transportation request to initiate a target transport activity within a target city. The transportation request may be send by a passenger by operation a mobile computing device (e.g., the terminal 130) for ordering a transportation service, and the request receiving unit 1410 may receive the transportation request via the network 120. The transportation request may include information on at least a departure POI and a destination POI, based on which the target transport activity may be arranged.

In 1520, the group identification unit 1420 may identify, from the plurality of city groups (resulting from the operation 430), a target city group of the target city using a classifier. The classifier may be obtained based on the result of the grouping in the operation 430 illustrated in FIG. 4. Descriptions of the obtaining of the classifier have been provided in connection with FIG. 4 and are not repeated herein.

In some embodiments, the classifier may take a graph representation as its input. Correspondingly, the group identification unit 1420 may generate a target graph representation of the target city based on transportation data relating to transport activities within the target city. The group identification unit 1420 may generate the target graph representation via operations the same as or similar to the ones through which the first graph representation sub-module 310 generates a first graph representation of a city, which are not repeated herein.

In some embodiments, the classier may implement the classification by comparing the target graph representation of the target city with the second featured graph of each of the plurality of city groups. By operating the classifier, the group identification unit 1420 may obtain, for each of the plurality of city groups, a second similarity indicator indicating the similarity between the target graph representation of the target city and the second featured graph representation of the city group, and designate, as the target city group, a city group of the plurality of groups having a highest similarity via the second similarity indicator. The group identification unit 1420 may obtain a second similarity indicator by using the kernel K_{G} involved in the operation 420 to treat the target graph representation and the corresponding second featured graph representation.

In some embodiments, the classier may be obtained via a machine-learning algorithm based on the transportation data and the labels for labeling the plurality of cities with their clusters. The group identification unit 1420 may identify the target city group of the target city by inputting transportation data relating to transport activities within the target city into the classifier.

In 1530, the target transportation type identification unit 1430 may identify, based on at least one POI included in the transportation request, a target transportation type of the target transport activity. The at least one POI may be the departure POI and/or the destination POI. For example, the target transportation type identification unit 1430 may identify a POI type of the at least one POI (e.g., via a look-up table), and identify the target transportation type using the identified POI type.

In 1530, the management unit 1430 may provide based on the strategy associated with the target group and the target transportation type, first data to a mobile computing device associated with a vehicle involved in the target transport activity. The first data may cause the vehicle to be more frequently or less frequently involved in the transport activities the same as or similar to the target transport activity.

For example, the management unit 1430 may determine, based on the strategy, whether the target transportation type is a transportation type to be promoted or to be restricted, and generating the first data accordingly. In some embodiments, the strategy may include a rulebook including associations between transportation types and correspond promotion/restriction rules. The management unit 1430 may search the target transportation type in such a rulebook, and generate the first data according to the rule associated with the target transportation type.

In some embodiments, the first data may cause the mobile computing device to generate a presentation on a display of the mobile computing device. The presentation may include information to encourage or discourage a user of the mobile computing device to participate the transport activities the same as or similar to the target transport activity. The mobile computing device may include an application related to the online-to-offline transportation service platform. After receiving the first data (e.g., via the network 120), the mobile computing device may generate the presentation on a display. For example, the mobile computing device may be a mobile phone and the display may be the screen or touchscreen of the mobile phone. As another example, the mobile computing device may be an on-board computing device which may project the presentation on the windshield (serving as the display) of the vehicle.

The user may be a passenger ordering a transportation service or a driver providing the transportation service. The information to be presented to the user may encourage or discourage the user to participate transport activities of the target transportation type. For example, the information may include discount or increased share for encouraging the user, or include increased fee or decreased share for discouraging the user. As another example, the information may include text and/or graphs promising a better outcome or warning a possible risk for participating transport activities of the target transportation type. Still as another example, the information may include a region where transportation requests or transportation services of the target transportation type are easier to receive.

In some embodiments, the vehicle may be an unmanned vehicle controlled by the mobile computing device (e.g., on-board). The first data may modify one or more parameters of the mobile computing device to, for example, change the cruising manner of the vehicle or to change a response of the vehicle towards transportation request corresponding to the target transportation type. For example, the first data may change the cruising manner of the vehicle such that the vehicle may cruise in a region where the transportation requests of the target transportation type may be easier or harder to receive. As another example, the first data may cause the vehicle to accept the transportation requests of the target transportation type in a higher or lower frequency.

The regulating of transportation via the process 1500 may be beneficial for the platform and for the cities. For example, by encouraging a driver or setting an unmanned vehicle to participate a certain type of transport activities, needs of such transport activities may be fulfilled in cities where such transport activities are prevailing or in great need. As another example, by discouraging a driver/passenger or restricting an unmanned vehicle to participate a certain type of transport activities in a city at a certain time period (it is noted that a POI type or a transportation type may further relate to a specific time period in some embodiments) such as rush hours specific to the city and the type of transport activities, the transportation state of the city may be improved.

Having thus described the basic concepts, it may be rather apparent to those skilled in the art after reading this detailed disclosure that the foregoing detailed disclosure may be intended to be presented by way of example only and may be not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment may be included in at least one embodiment of the present disclosure. Therefore, it may be emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that may be not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, may be not intended to limit the claimed processes and methods to any order except as may be specified in the claims. Although the above disclosure discusses through various examples what may be currently considered to be a variety of useful embodiments of the disclosure, it may be to be understood that such detail may be solely for that purposes, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purposes of streamlining the disclosure aiding in the understanding of one or more of the various inventive embodiments. This method of disclosure, however, may be not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein may be hereby incorporated herein by this reference in its entirety for all purposes, excepting any prosecution file history associated with same, any of same that may be inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and describe.

1. A method for analyzing and managing transportation, implemented on at least one device, each of which includes one or more storage devices and at least one processor, the method comprising:
generating, by the at least one processor, for each of a plurality of geographic regions, a first graph representation based on transportation data relating to transport activities within the geographic region;
obtaining, by the at least one processor, for any two of the plurality of geographic regions, via a graph kernel based algorithm, a first similarity indicator measuring a similarity between the first graph representations of the any two of the plurality of geographic regions;
grouping, by the at least one processor, based on the first similarity indicators, the plurality of geographic regions into a plurality of groups; and
for each of the plurality of groups:
identifying, by the at least one processor, at least one featured transportation type of the group; and
associating, by the at least one processor, a strategy to the group to promote or restrict transport activities of the at least one featured transportation type of the group.

2. The method of claim 1, wherein:
the transportation data includes, for each of the transport activities, points of interest (POIs), which correspond to a departure location and a destination location of the transport activity respectively and belong to a plurality of POI types;
the first graph representation includes a plurality of first vertices and a plurality of first edges;
each of the plurality of first vertices represent a POI type of the plurality of POI types; and
each of the plurality of first edges represent transport activities between the POIs of the corresponding POI types, and has a weight associated with at least a number of the transport activities represented by the first edge.

3. The method of claim 2, wherein the generating, for each of a plurality of geographic regions, a first graph representation based on transportation data comprises:
generating, based on the transportation data associated with the geographic region, a second graph representation of the geographic region, wherein the second graph representation includes a plurality of second vertices and a plurality of second edges;
selecting the plurality of first vertices from the plurality of second vertices based on the second graph representation; and
generating the first graph representation using the plurality of first vertices.

4. The method of claim 3, wherein the selecting the plurality of first vertices comprises:
associating a score with each of the plurality of the second vertices;
for each of the plurality of second vertices:
(i) obtaining scores of one or more neighbor vertices of a current second vertex, the one or more neighbor vertices connecting to the current second vertex with one or more second edges;
(ii) obtaining weights of the one or more second edges;
(iii)updating, based at least on the scores of the one or more neighbor vertices and the weights of the one or more second edges, the score of the current second vertex; and
(iv) repeating (i), (ii), and (iii)until a termination condition is satisfied; and
selecting the plurality of first vertices based on the scores of the second vertices.

5. The method of claim 3, wherein:
the second graph representation is in a form of an adjacency matrix, wherein each element of the adjacency matrix is a weight of the corresponding second edge; and
the selecting the plurality of first vertices from the plurality of second vertices comprises:
obtaining a stochastic matrix based on the adjacency matrix;
calculating an eigenvector of the stochastic matrix; and
selecting the plurality of first vertices from the plurality of second vertices based on the eigenvector.

6-14. (canceled)

15. A system for analyzing and managing transportation, comprising:
at least one storage medium including a set of instructions for training a learner model; and
at least one processor in communication with the storage medium, wherein when executing the set of instructions, the at least one processor is directed to:
generate, for each of a plurality of geographic regions, a first graph representation based on transportation data relating to transport activities within the geographic region;
obtain, for any two of the plurality of geographic regions, via a graph kernel based algorithm, a first similarity indicator measuring a similarity between the first graph representations of the any two of the plurality of geographic regions;
group, based on the first similarity indicators, the plurality of geographic regions into a plurality of groups; and
for each of the plurality of groups:
identify at least one featured transportation type of the group; and
associate, a strategy to the group to promote or restrict transport activities of the at least one featured transportation type of the group.

16. The system of claim 15, wherein:
the transportation data includes, for each of the transport activities, points of interest (POIs), which correspond to a departure location and a destination location of the transport activity respectively and belong to a plurality of POI types;
the first graph representation includes a plurality of first vertices and a plurality of first edges;
each of the plurality of first vertices represent a POI type of the plurality of POI types; and
each of the plurality of first edges represent transport activities between the POIs of the corresponding POI types, and has a weight associated with at least a number of the transport activities represented by the first edge.

17. The system of claim 16, wherein to generate, for each of the plurality of geographic regions, the first graph representation based on the transportation data, the at least one processor is directed to:
generate, based on the transportation data associated with the geographic region, a second graph representation of the geographic region, wherein the second graph representation includes a plurality of second vertices and a plurality of second edges;
select the plurality of first vertices from the plurality of second vertices based on the second graph representation; and
generate the first graph representation using the plurality of first vertices.

18. The system of claim 17, wherein to select the plurality of first vertices, the at least one processor is directed to:
associate a score with each of the plurality of the second vertices;
for each of the plurality of second vertices:
(i) obtain scores of one or more neighbor vertices of a current second vertex, the one or more neighbor vertices connecting to the current second vertex with one or more second edges;
(ii) obtain weights of the one or more second edges;
(iii)update, based at least on the scores of the one or more neighbor vertices and the weights of the one or more second edges, the score of the current second vertex; and
(iv) repeat (i), (ii), and (iii)until a termination condition is satisfied; and
select the plurality of first vertices based on the scores of the second vertices.

19. The system of claim 17, wherein:
the second graph representation is in a form of an adjacency matrix, wherein each element of the adjacency matrix is a weight of the corresponding second edge; and
to select the plurality of first vertices from the plurality of second vertices, the at least one processor is directed to:
obtaining a stochastic matrix based on the adjacency matrix;
calculating an eigenvector of the stochastic matrix; and
selecting the plurality of first vertices from the plurality of second vertices based on the eigenvector.

20. The system of claim 16, wherein to identify the at least one featured transportation type of the group, the at least one processor is directed to:
obtain a first featured graph representation of the group;
identify a plurality of transportation types based on the first featured graph representation;
quantify each of the plurality of transportation types by associating the transportation type with a quantified number based at least on weights of edges of the first featured graph representation associated with the transportation type; and
select, from the plurality of transportation types, the at least one featured transportation type of the group by ranking the plurality of transportation types based on the quantified numbers.

21. The system of claim 15, wherein the at least one processor is further directed to:
receive a transportation request to initiate a target transport activity within a target geographic region;
identify, from the plurality of groups, a target group of the target geographic region using a classifier, wherein the classifier is obtained based on the result of the grouping;
identify, based on at least one POI included in the transportation request, a target transportation type of the target transport activity; and
provide, based on the strategy associated with the target group and the target transportation type, first data to a mobile computing device associated with a vehicle involved in the target transport activity, causing the vehicle to be more frequently or less frequently involved in transport activities of the target transportation type.

22. The system of claim 21, wherein the first data causes the mobile computing device to generate a presentation on a display of the mobile computing device, wherein the presentation includes information to encourage or discourage a user of the mobile computing device to participate transport activities of the target transportation type.

23. The system of claim 21, wherein:
the vehicle is an unmanned vehicle controlled by the mobile computing device; and
the first data modifies one or more parameters of the mobile computing device to change the cruising manner of the vehicle or to change a response of the vehicle towards transportation request corresponding to the target transportation type.

24. The system of claim 21, wherein to identify, from the plurality of groups, the target group of the target geographic region using the classifier, the at least one processor is directed to:
generate a target graph representation of the target geographic region based on transportation data relating to transport activities within the target geographic region;
obtain, for each of the plurality of groups, a second similarity indicator indicating a similarity between the target graph representation and a second featured graph representation of the group; and
designate, as the target group, a group of the plurality of groups having a highest similarity via the second similarity indicator.

25. The system of claim 21, wherein to identify, from the plurality of groups, the target group of the target geographic region using the classifier, the at least one processor is directed to:
input transportation data relating to transport activities within the target city into the classifier, wherein the classifier is trained via a machine-learning algorithm using a training dataset that is obtained based on the result of the grouping.

26. The system of claim 15, wherein a graph kernel involved in the graph kernel based algorithm is a kernel based on walks or paths, or a kernel based on sub-trees.

27. The system of claim 15, wherein to group, based on the first similarity indicators, the plurality of geographic regions into the plurality of groups, the at least one processor is directed to:
cluster, based on the first similarity indicators, the plurality of geographic regions via a clustering algorithm to obtain a plurality of clusters, each of which corresponds to one of the plurality of groups.

28. The system of claim 27, wherein the clustering algorithm is a K-means algorithm, a hierarchical cluster analysis algorithm, or a graph community detection algorithm.

29. A non-transitory computer readable medium, comprising at least one set of instructions compatible for analyzing and managing transportation, wherein when executed by at least one processor of one or more electronic devices, the at least one set of instructions directs the at least one processor to:
generate, for each of a plurality of geographic regions, a first graph representation based on transportation data relating to transport activities within the geographic region;
obtain, for any two of the plurality of geographic regions, via a graph kernel based algorithm, a first similarity indicator measuring a similarity between the first graph representations of the any two of the plurality of geographic regions;
group, based on the first similarity indicators, the plurality of geographic regions into a plurality of groups; and
for each of the plurality of groups:
identify at least one featured transportation type of the group; and
associate, a strategy to the group to promote or restrict transport activities of the at least one featured transportation type of the group.
